(19) United States
(12) Patent Application Publication
(10) Pub. No.: US 2019/0287162 A1
(43) Pub. Date: Sep. 19, 2019

(54) METHOD, APPARATUS AND PROGRAM TO LINK USERS TO MANUFACTURERS

(71) Applicant: MI SOFTTECH, INC., Purcellville, VA (US)

(72) Inventors: Mustafa ISMAIL, Purcellville, VA (US); Mustafa SABRI, Solingen (DE); Sebastian HARKE, Berlin (DE)

(21) Appl. No.: 16/318,676

(22) PCT Filed: Jul. 21, 2016
(86) PCT No.: PCT/US16/00061

§ 371 Date: Jan. 17, 2019

(51) Int. Cl. G06Q 30/06; G06F 16/955; G06F 16/954; G06Q 30/08

(52) U.S. Cl. CPC G06Q 30/0643; G06Q 30/08; G06F 16/954; G06F 16/9558

(57) ABSTRACT

A novel user interface between a vehicle user and a manufacturer providing a transfer of consumer data to the manufacturer to change production line parameters based on safety, service and consumer experience with the vehicle. The user interface which can include a virtual reality module further provides an automated system allowing manufacturer, user and workshops managing their assets and services with an electronically adjustable database to complete the entire lease purchase application process of the customer and/or workshop service request online including negotiations, financing, bank approvals, insurance package, vehicle registration service, workshop services and delivery of the vehicle to the customer after a lease/purchase contract is concluded with online transaction processing. The interface can provide a workshop service in which the customer has the option to request a car for fleet purchase/lease or a single vehicle for a group of lessors and optionally allow a customer to trade in their vehicle and present an offer directly to dealerships.

### COPYRIGHT/TRADEMARK NOTICE

This document includes subject matter that is also subject to U.S. and International copyright and trademark protection. The copyright and trademark owner grants permission to copy this document in the U.S. Patent And Trademark Office as well as in corresponding Patent Offices but reserves all its rights to the trademarks and software, data and GUI interface described herein including the appended drawings. Copyright © 2015 MI Softtech, Inc. All Rights Reserved.

### BACKGROUND OF THE INVENTION

### 1. Field of the Invention

The invention pertains to a system, method and apparatus for connecting a purchaser or the end user to a manufacturer of a vehicle through a server having a horizontal array of manufacturers and a vertical array of service providers which improves vehicle safety and quality by a combination of hot links and cold links. More particularly the invention provides for the transfer of information between purchaser or the end user and the manufacturer to provide the manufacturer with actual use data for changing manufacturing and use of problematical assembly line components while providing the end user with electronically adjustable tools for the immediate selection, financing, insuring, registering and obtaining the delivery of a new vehicle and if desired the retail or trading an existing vehicle with a one stop shop experience including records, warranty and after transfer care services.

### 2. Description Of The Prior Art

The prior art includes a plethora of data and information that is bifurcated and compartmentalized into a plentitude of different informational databases. These databases are generally scattered and not vertically or horizontally linked. More often than not these links are cold links that require user intervention such as opening files and making commands to access the desired information. This process results in frustration and delay on the part of the consumer or end user and needless delay in the manufacturer changing components, accessories, or procedures that are detrimental to safety and the reputation of the manufacturer.

The lack of integration of vertical and horizontal databases has not been good for either the consumer, end user or the manufacturer. Manufacturers have been hampered by not having direct access to the end user through a server and having direct access to actual operational data needed to evaluate the integrity and quality of components in actual use in a vehicle. Typically a component such as semi autonomous driver systems, tires, engines, air bags and the like are available from a plurality of suppliers. However without actual in use data a defective component can continued to be used in the assembly line far longer than it would be if end user data was immediately available to the manufacturer. Similarly actual use data from the end user would assist a manufacturer in knowing whether the mileage and vehicle pollution systems and manufacturers claims for the vehicle are within acceptable parameters and if not the manufacturer can change its production assembly line hereby limiting vehicle recalls and product liability problems. In addition to hot links and cold links a direct portal between the manufacturer and the end user through the server allows a manufacturer direct access to the end user, showcase new products and specials and obtain direct consumer preference data to its products and options.

The inadequate integration of vertical and horizontal databases has hampered the end user by wasting time and money. An end user in selecting a vehicle generally first selects a particular dealer which prevents consideration of available comparable options from other dealers. Then once the dealer is selected the average consumer spends four to eight hours at the car dealership in multiple rounds of negotiating with the dealer. Then additional time is spent negotiating financing with the dealer or with banks and thereafter with insurance and the process of licensing and registration due to an inadequate vertical integration and electronic adjustment of databases. In this process the end user does not get the best total price since there is little if any bidding for the business of the end user.

As used herein and in the accompanying claims the word “vehicle” is used collectively to include transportation devices without limitation such as automobiles, trucks motorcycles, vans, buses, planes, boats and construction equipment having a motor. A horizontal integration among a plurality of manufacturers of different vehicles is provided which allows the user to select a particular type of vehicle for example automobiles at which time a plurality of automobile manufacturers are displayed online. Comparisons are provided among the automobile manufacturers in a horizontal integration of automobile manufacturers. Once a particular automobile manufacturer is selected a vertical integration of information and data provides sale and leasing options with further integration and electronic adjustment of financing, insurance, licensing, registration, titling and all local requirements for tags to enable the entire transaction to be completed online as well as a delivery date for the selected vehicle. In each of the vertical integrated steps a horizontal integration of suppliers bid for the end user's business to insure the lowest possible price is secured. In addition the novel integrated method and system links the end user and manufacturer to dealers and vehicle outlets to allow the end user to in the same transaction to retail, sell or trade a currently owned vehicle if desired. In operation the combination of hot and cold links provide operational data on the use of a vehicle to avoid having to resort to standardized vehicle publications such as Kelly's Blue Book® or similar sources.

The known prior art does not provide such a complete vertical and horizontal integration of information and data that links the end user directly to the manufacturer through a server with an electronic adjustment to complete the entire transaction online. The best known prior art in use provides a limited horizontal listing of databases such as Edmunds.com of Santa Monica, Calif. which provides comparative information for consumers researching cars and cars.com of Chicago, Ill. that allows users to look up information and reviews for cars as well as www.consumerreports.org. These examples of prior art do not provide a complete horizontal integration of transportation manufacturer databases. The known prior art does not include transportation manufacturers for automobile, boats, motorcycles, buses and planes. In the prior art an end user of airplanes would have to search for aircraft databases or charter services such as Blue Starlets based in New York, N.Y., and for boats Yacht Charter Fleet in Dorset, England. Moreover in not directly linking the end user to the manufacturer through a server the end user is forced to waste time searching for databases and outlets that would otherwise be known to the manufacturer that could respond directly to the end user's needs. Indeed most vehicle manufacturers are not linked at all to the end consumer or purchaser.

The only known vehicle prior art providing a manufacturer consumer link via the Internet is Testa Motors, Inc. of Palo Alto, Calif., www.teslamotors.com. The link does not provide a horizontal integration to other vehicles as well as a point of sale (POS), a dealer manufacturer system (DMS), customer relationship manager (CRM) or a customer dashboard. The Tesla website allows a customer to schedule a test drive, select colors and options and arrange a lease or purchase financing and schedule a later delivery date for the selected vehicle.

The Tesla website does not have a CRM module to track sold or leased vehicles to insure transferred vehicles are tracked in terms of safety, performance, warranty and service requirements. Most importantly Tesla does not provide a hot link to the vehicle itself to insure the vehicle is operating within parameters set or intended by the manufacturer. The CRM manager insures that each of these aspects are tracked along with government accident records, service difficulties in the transferred vehicle as well as vehicles having the same or similar components and consumer complaints to insure the vehicle and the components of the vehicle perform as claimed by the manufacturer as well as the components of the sub component manufacturer so that component problems are corrected or changed in the assembly line as soon as practical.

The Tesla website does not provide a point of sale (POS) module where all transactional requirements having horizontal integration of financing options with banks and other lenders, with horizontal integration of purchasers or bidders for the customer or end user's existing trade in, horizontal integration of insurance companies along with all links to complete the entire transaction online instantaneously. The POS module insures that the customer or end user not only can immediately complete the transactions on line but also insures the customer or end user gets the best available deal at any given instant in time.

The Tesla website also does not provide a customer dashboard or manufacturer or dealer dashboard in which the best price for a trade in vehicle or the lowest price for each service needed to complete the transaction is displayed immediately on the computer screen. The Tesla website does not provide a DMS module in which individual dealers provide competitive pricing of all services needed to complete the transaction online as well as a relationship between the DMS module and the CRM to provide service and updates on warranty requirements throughout the time the vehicle is sold or eased to the end consumer or links back to the manufacturer through the CRM to insure the best trade in value for the vehicle based on an actual operational history of the vehicle.

The best known prior art in use also provides a limited degree of vertical integration of databases. AutoTrader.com in Atlanta, Georgia offers limited listings for new and used cars for sale from dealerships and private sellers. This prior art in use does not link the end user to the manufacturer or provide a complete vertical and horizontal link of databases. Some manufacturers through their dealers or directly provide financing, insurance, licensing and vehicle registration services along with trade in services of the user's existing vehicle(s). Sometimes these services are available at competitive prices sometimes they are not due to limited cold links to alternative competitive databases. In contrast hot links to alternative data bases of the invention assure the end user that the best competitive price will be provided by the manufacturer from other available hot links to alternative data bases or sources that bid for the end user's business to provide the best bottom line price.

The known prior art also includes numerous examples of accident reports, incident reports and service reports for automobiles, aircraft, boats and equipment as well as consumer complaints that sit in databases often unknown to manufacturers and not linked to the manufacturer through a server computer. These accident, incident and service reports tragically mount up until they reach recall proportions before changes are made in vehicle manufacturing or changing component suppliers. This information problem is resolved for the manufacturer by a server having access to the end user and vehicle service provider and the most important databases needed by the manufacturer to change components in the manufacturing assembly line or altering components based on data from the end user. For example if a component supplied by a particular component supplier has caused injury or has repeated service problems it can be switched earlier in the manufacturers' assembly line. As another example a repeated request from the end user for a convertible option or different tires or rims can be accommodated by a change in the assembly line rather sending a vehicle out to a third party for customization. Also in recent years some of the information needed to change production is available not only from the end user but also from the computer on board the vehicle. In providing direct access between the end user and manufacturer and the vehicle service provider the novel server can assemble and provide information to change the manufacturing of a vehicle before consumer complaints and service difficulties become incidents and incidents become accidents. This information becomes more relevant in the future where autonomous and semi autonomous vehicles are introduced and defects, tampering and hacking of computer components become more prevalent. Linking such problems to the manufacturer at the earliest possible time allows the manufacturer to make changes in software or hardware or adopt an alternative component in the manufacturing assembly line.

In this regard it has been recently reported that a modern vehicle uses more than 100 million lines of code to control everything from engine management to infotainment while a modern F35 fighter jet only uses 8 million lines of code. Hacking into the lines of code in vehicles has become one of the auto industry's biggest problems since open portals have been used by hackers to gain access to systems to remotely control a vehicle and in one case drive the vehicle remotely into a ditch. The problem of remote control of vehicles demonstrates the need for direct links between consumers or end users and accident and incident reports to get more quickly and reliably to a manufacturer so that hardware, software or both can be changed as quickly as possible in the assembly line.

The available patented and published prior art has also been researched. The most relevant prior art includes Grossman, et al. U.S. Pat. No. 8,370,253 which provides for a computerized method of brokering multiple leased products from multiple providers in an interactive credit brokering service integrated with a point-of-sale leasing system. While U.S. Pat. No. 8,370,253 includes sale and leasing of products it does not link the end user or vehicle service provider directly to the manufacturer through a server.

Parent, et al. U.S. Pat. No. 7,395,275 provides an electronic commerce system for facilitating transactions based on asset profile and providing for the disposal of assets through the Internet. Like Grossman, et al. the end user is not linked to the manufacturer in the acquisition and transfer of the plurality of assets which in this case is industrial equipment.

Joseph U.S. Pat. No. 6,965,874 provides for an online system for transferring leased vehicles. Other online leasing systems include Breen U.S. Pat. No. 7,941,354, Revanuru, et al. U.S. Pat. No. 8,122,108, Perez U.S. Pub. 2015/0206228, Casper U.S. Pub. 2014/0304175, and Yellow Jiniyi Canadian Patent ID CN1334536A. These leasing systems and links do not include the manufacturer and do include vertical links to insurance, financing, maintenance, registering and licensing with horizontal links to vertical link to establish a bidding process for the end user's business.

Anabitawi, et al. U.S. Pub. 2003/0046179 represents a system for linking a manufacturer, customer and distribution center together to provide an online shopping experience to provide the right vehicle at the right time and at the right price. The publication does not provide for integration either vertically or horizontally and does not provide an electronic adjustment of variables to complete a transaction or provide for the disposal of the end user's existing vehicle with an electronic adjustment of the variable parameters. Instead links are provided for posting an existing vehicle to a bulletin board. Finally there is no link between the manufacturer and end user that would provide information to transform manufacturing procedures or components based on virtual reality user inputs and/or safety data inputs.

The known approaches have not unified horizontal and vertical databases with a seamless server resource for integrating manufacturers with end users. The integration of the manufacturer with the end user provides both with advantages in managing resources and efficiently providing for the transfer of data and information to complete a sale or lease transaction of vehicle, monitor the safety of that vehicle and change manufacturing assembly criteria to promote safety of new products and components.

There is consequently a need to link end users with a manufacturer in a seamless integrated point of sale lease system and integrate the vertical elements needed to complete the transfer in a point of sale or lease system through a server.

There is a need to link end users, dealers and workshops with a manufacturer in the point of sale or lease system to service currently owned vehicles and provide the manufacturer with serviceability reports involving previously manufactured vehicles.

There is a need to link manufacturers with end users with hot links and cold links to monitor the service and incidents and accidents involving a manufactured vehicle to change manufacturing procedures or change a component supplier of components used in the manufacture of the vehicle.

There is a further need to link manufacturers, end users and service facilities to monitor the reliability of the vehicle and determine if the vehicle has been properly serviced and therefore complies with warranty requirements.

There is further a need to link manufacturers to end users to determine if manufacturer mileage, pollution and other standards are within acceptable parameters to prevent recalls and liability.

There is further a need to link manufacturers to end users with manufacturers to allow users to select components and options for a vehicle to produce a customized vehicle and allow the manufacturer to transform the assembly line based on real user inputs and data.

These and other advantages and aspects of the invention will be discussed in the following Summary Of The Invention.

### SUMMARY OF THE INVENTION

Information is essential to the manufacturer in manufacturing a safe and reliable vehicle and it is essential to the end user in selecting a safe and reliable vehicle at the most favorable terms. The problem in the information age is the information is in a plethora of databases that themselves are dispersed and constantly being changed and updated. Not having the right information at the right time in a logical format has created an information problem. Also in recent years some of the information needed to change production is available not only from the end user but also from the computer on board the vehicle. In providing direct access between the end user and manufacturer and the vehicle service provider the novel server can assemble and provide information to change the manufacturing of a vehicle before consumer complaints and service difficulties become incidents and incidents become accidents. This information becomes more relevant in the future where autonomous and semi autonomous vehicles are introduced and defects, tampering and hacking of computer components become more prevalent. Linking such problems to the manufacturer at the earliest possible time allows the manufacturer to make changes in software or hardware or adopt an alternative component in the manufacturing assembly line.

This information problem is resolved for the end user by a server having access to the manufacturer and the most important databases needed by the end user and the vehicle manufacturer and provide an electronic adjustment of each of the databases with a relational database management tool to provide the best information to the end user and the manufacturer at any given point in time by employing a combination of hot links and cold links between the manufacturer service providers and the end user.

The server and relational database management tool can be operated directly by the vehicle manufacturer or through a third party with the combination of hot and cold links between the manufacturer and end user which preferably includes a hot link to a computer in the vehicle itself. The hot link to the vehicle itself provides instantaneous information or real time data on the operation of the vehicle. This data on one end of the spectrum allows the server to collect mundane information on the operating parameters of the vehicle and its systems and subcomponents and on the other end of the spectrum allows the server to collect vital safety information such as whether an autonomous or semi autonomous system has been or is being improperly changed or hacked.

The invention includes the application of telematics where black boxes and modules now installed in cars for insurance purposes to send driver information to set insurance rates are now utilized by the manufacturer to send data directly to the manufacturer and consumer to augment the consumer manufacturer link. The telematics module in the preferred embodiment sends information to the manufacturer through a manufacturer dealer worker (MDWI) link or directly to manufacturer factory (FI) so that issues of warranty, service are properly satisfied or in the case of software defects are sent directly to the manufacturer or through the novel server (NS10).

The telematics module not only serves to address safety and security problems but also can be used to reduce the number of vehicles owned by a family or shared in a fractionalized or shared ownership arrangement particularly where the autonomous and semi autonomous features are linked to the consumer through the internet or a communication link. Autonomous vehicles will be able to drive and communicate with an owner or group of owners and provide shared use advantages so that when one of the owners is working the other owner can be using the vehicle or the vehicle can be leased out and making money while the owner is working and then returned autonomously to pick the owner up or returned to a garage or parking space to pick the owner up and work and provide information to the owner or dealer or workshop as to its activities or even be called into the dealer or workshop and drive there autonomously while at all times providing the right information at the right time to the owner, manufacturer or dealer through the novel server. The electronic resolution of the information problem extends not only from use but also to the acquisition of a vehicle.

The electronic resolution of the information problem also allows an end user or consumer to horizontally select from a multitude of transportation options using an online computer. Once one of the transportation options is selected a list of manufacturers are given for the transportation option, for example automobiles. Once a particular manufacturer is selected a portal opens connecting the particular manufacturer and their dealers to the user to provide purchase, lease and possible other renting or shared purchase or ownership options.

Once selection of a make and model is made from dealers having that make and model display corresponding vehicles for lease and other possible options portals open to provide a vertical integration of links to complete the transaction. These vertical links include everything necessary to complete the transaction and arrange the soonest possible delivery of the vehicle. The vertical links provide an electronically adjustable interrelation of links to options selected by the end user and include financing, insurance, delivery costs, taxes, registration and licensing fees and offers for the trading, sale or disposal of existing vehicle(s) to provide total purchase price or monthly lease price to complete the online point of sale or lease system with the novel interact based server. All necessary documents, title, registration, bill of sale and local required documents are made available to print out or store electronically.

The electronic resolution of the information problem allows the manufacturer to showcase new vehicle models, specials and obtain direct consumer input and real time data as to consumer preferences as to vehicle options and accessories as well as customization data and preferences that are useful in vehicle assembly line production and planning. This data provides immediate data to change the production line from an estimated vehicle demand to an actual vehicle demand database.

The linking of the end user to the manufacturer with the end user with the manufacturer, dealer and customer through the novel internet based or virtual reality server provides more important long term benefits in vehicle production, warranty and safety issues. This link allows the manufacturer to obtain service reports and service problems from the service workshop as well as the end consumer as well as accident and incident reports involving sold or leased vehicles. These accident, incident, service and customer reports allow the manufacturer to quickly change assembly line components or procedures to limit the amount of damage that can be caused by a defective component such as an airbag.

The manufacture and assembly of new vehicles involves the use of components that are common to a number of different vehicle manufacturers. These components and sometimes their subcomponents are available from different suppliers. When the novel server which will be alternatively referred to herein and in the drawings as the NGINE™ server collects data on a number of accident and incident reports on a particular component or subcomponent the manufacturer can employ the NGINE™ server to more quickly change the component or subcomponent in the assembly of future vehicles.

The NGINE™ server also provides information and a database on warranty questions and issues. The NGINE™ server allows a manufacturer to determine whether an accident or incident was the result of a breach of warranty or vehicle misuse or abuse. The NGINE™ server allows a manufacturer to obtain data from the computer on board the vehicle through the NGINE™ server which can be tied directly to the vehicle VIN number.

The NGINE™ server and data from the NGINE™ server is also valuable to the manufacturer as well as the end user at the end of the lease and/or the sale or disposal of an existing vehicle when a new lease or a new vehicle is sought by the end user. The NGINE™ server data assists the manufacturer or bidder in determining the fair market value of a vehicle which the end user desires to sell, trade in or otherwise replace.

The novel system provides a complete vehicle transaction to be completed through the internet with horizontal and vertical portals that cut cost, save time and promote the manufacture of safer vehicles. The system includes a server configured to receive and provide data on a plurality of vehicles and horizontal modules linking an end user or consumer horizontally to a plurality of vehicles or vehicle manufacturers with vertical links to complete the transaction on line. The vertical links have associated horizontal links to provide the best price or terms offered in each vertical link to complete the entire transaction online with an electric adjustment device to electronically adjust data in the form of bids or offers in each vertical link selected by the end user or consumer to provide the best times for the transfer of a new vehicle or the transfer of a new vehicle and disposal of an existing vehicle.

The novel system includes a plurality of optional modules that can be selected by the end user or consumer. These modules include a service management module, a bid module a trade in module, a feedback module, a vehicle maintenance module, an end user dashboard modules, a vehicle manufacture dashboard module, a service maintenance module, a news and blog module, a live chat module, a customer relationship management module, a roadside service module, a comparative vehicle module and a voice recognition module.

The invention provides for electronic apparatus linking processors through the internet along with program code needed to complete an entire transfer of a vehicle on line. These program codes include horizontal links to a plurality of vehicle manufacturers or a plurality of vehicles from a manufacturer directly to the end user or consumer. The program code provides plurality of horizontal links to different types of vehicles from different manufacturers or a plurality of different vehicles from a single manufacturer. Thereafter the program code includes a plurality of vertical links to complete the transfer of the vehicle entirely on line. Each of the vertical links include program code for a plurality of horizontal links for each vertical link selected by the end consumer so that the best price or bid can be obtained from each vertical link and an electronic adjustment device to select and tabulate the lowest total price for the delivery of the vehicle.

The program code includes a trade in program code, a vehicle maintenance code, a vehicle tracking code preferably based on the vehicle identification number VIN. The program code optionally includes vehicle service code and code to record data including accident reports, incident reports, vehicle computer reports and service reports from a vehicle maintenance facility which are collected, processed and relayed through the internet to the vehicle manufacturer or through a host website computer connected to the manufacturer to change one or more vehicle components in the vehicle assembly line.

The faster data from accidents, incidents, service problems are tabulated and transmitted to the manufacturer the faster the assembly line or a vehicle component in the assembly line can be changed. As will be recognized vehicle manufacturers use similar components in a number of different vehicles that are common to a number of different vehicles that are common to a number of different manufacturers. The use of common components has become more wide spread and the use of common components generally spans a number of models and model years. These components may be safety air bags, tires and other components such as computer parts that sometimes are prone to failure. In tracking all vehicles with similar components the data collected and processed allows the vehicle manufacturer to determine at the earliest possible time of potential defects that allows the manufacturer to change the assembly line at the earliest possible time to avoid or limit potential liability since its vehicle and vehicles with similar components are tracked all over the world.

Consumers in addition to manufacturers benefit from the horizontal and vertical integration of data. Consumers not only benefit from improved safety but also from a one-stop shop experience with flexible financing and transfer and delivery options without sacrificing valuable time. Transfer options include sale, lease, rental and fractional ownership options. The consumer can research and purchase cars, trucks, motorcycles, buses, boats and airplanes from all over the world and access market statistics and rankings and similar products as well as financing from a variety of banks and sources and complete the entire purchase on line.

Other features, objects and advantages will be further apparent to one skilled in the art from the following drawings taken in conjunction with the detailed description which are included for purposes of illustration and not by limitation.

### BRIEF DESCRIPTION OF THE DRAWINGS

The following drawings are for purposes of illustration without limiting the scope or content of the invention and constitute a part of the specification together with the background and summary given above together with the detailed description and best mode explain the various aspects of the invention, in which:

FIG. 1 is a diagram illustrating a server with modules linking a user to a manufacturer which in the best mode is an NGINE™ internet cloud Software-as-a-Service based system;

FIG. 2 is a diagram of one embodiment of the invention illustrating the server's ability to generate statistics and data with an internet connect to a plurality of horizontal and vertical databases to complete transfer of vehicle with workshops to transform products of the manufacturer;

FIG. 3 is a diagram illustrating a preferred manufacturer database in coherence with collected data by a server or a NGINE™ server and the consequential transformation of products and services;

FIG. 4 is an alternative embodiment of the invention in accordance with the best mode having a flowchart illustrating transactions handled by a web server or the NGINE™-server;

FIG. 5A and FIG. 5B is a flowchart illustrating an embodiment of the best mode of the server or NGINE™ server and its relationship to modules in the system;

FIG. 6A and FIG. 6B is a flowchart of a preferred embodiment illustrating access to a public and private areas of the server or the NGINE™-Portal;

FIG. 7 is a flowchart of an embodiment illustrating a user's access to a server or the NGINE™ server;

FIG. 8 is a flowchart of an embodiment illustrating the process of uploading and advertising of a vehicle on a server or the NGINE™ server;

FIG. 9 is a flowchart of an embodiment illustrating a process of leasing or purchasing a vehicle on a server or the NGINE™ server;

FIG. 10 is a flowchart of an embodiment illustrating a process of searching and booking a maintenance service on a server or the NGINE™ server;

FIGS. 11A and 11B is a flowchart of an embodiment illustrating a trade process on a server or the NGINE™ server;

FIG. 12 is a flowchart of an embodiment illustrating a process of searching for a trade transaction on a server or NGINE™ server;

FIG. 13 is a flowchart of an embodiment illustrating a search process for a Workshop Service Provider on a server or the NGINE™ server;

FIG. 14 is a flowchart of an embodiment illustrating a process to post a job for receiving a service and accepting a job offer from a Workshop Service Provider on a server or the NGINE™ server;

FIG. 15 is a flowchart of an embodiment illustrating a process to post a job for obtaining a service and accepting a job offer from a Workshop Service Provider on a server or the NGINE™ server;

FIG. 16 is a flowchart of an embodiment illustrating a process for searching a workshop service offer on a server or the NGINE™ server;

FIG. 17 is a flowchart of an embodiment displaying process for searching a workshop service request on a server or the NGINE™ server;

FIG. 18 is a flowchart embodiment displaying a Trade-In module on a server or the NGINE™ server;

FIG. 19 is a flowchart of an embodiment illustrating a ‘My Vehicle’ module on a server or the NGINE™ server;

FIG. 20 is a flowchart of an embodiment illustrating an optional ‘My Documents’ module on a server or the NGINE™ server;

FIG. 21 is a flowchart of an embodiment illustrating an optional ‘Messages’ module on a server or the NGINE™ server;

FIG. 22 is a flowchart of an embodiment illustrating an optional ‘My Account’ module on a server or the NGINE™ server;

FIG. 23 is a flowchart of an embodiment illustrating a ‘Workshop’ module on a server or the NGINE™ server;

FIG. 24 is an alternative embodiment of the flowchart of FIG. 9 illustrating a ‘Dashboard’ module on a server or the NGINE™ server;

FIG. 25 is a flowchart of an embodiment illustrating an optional ‘Question & Answer’ module on a server or the NGINE™ server;

FIG. 26 is a flowchart of an embodiment illustrating an optional ‘Share-My-NGINE™’ module on a server or the NGINE™ server;

FIG. 27 is a flowchart of an embodiment illustrating an optional ‘Number-Plate-Review’ module on a server or the NGINE™ server;

FIG. 28 is a flowchart of an embodiment illustrating an optional ‘I-Love-My-NGINE™’ module on a server or the NGINE™ server;

FIG. 29 is a flowchart of an embodiment illustrating an optional ‘Provide Service’ module on a server or the NGINE™ server;

FIG. 30 is a flowchart of an embodiment illustrating an optional ‘Made-To-Order’ module on a server or the NGINE™ server;

FIG. 31 is a flowchart of an embodiment illustrating a ‘Workshop Service Client’ module on a server or the NGINE™ server;

FIG. 32 is a flowchart of an embodiment illustrating a ‘Workshop Service Provider’ module of a server or the NGINE™ server;

FIG. 33 is a flowchart of an embodiment illustrating a ‘Trading’ module on a server or the NGINE™ server;

FIG. 34 is a flowchart of an embodiment illustrating an optional ‘Messages’ module on a server the NGINE™ server;

FIG. 35 is a flowchart of embodiment illustrating a ‘CRM’ module on a server or the NGINE™ server:

FIG. 36 is a flowchart of an embodiment illustrating a ‘Vehicle’ module on a server or the NGINE™ server;

FIG. 37 is a flowchart of an embodiment illustrating a preferred ‘Calendar’ module on a server or the NGINE™ server;

FIG. 38 is a flowchart of an embodiment illustrating a preferred ‘Nonpublic-Statistics’ module on a server or the NGINE™ server;

FIG. 39 is a flowchart of an embodiment illustrating an optional ‘Settings’ module on a server or the NGINE™ server;

FIG. 40 is a flowchart of an embodiment illustrating an optional ‘Invoices’ module on a server or the NGINE™ server;

FIG. 41 is a flowchart of an embodiment illustrating an optional ‘Swap’ module on a server or the NGINE™ server;

FIG. 42 is a flowchart of an embodiment illustrating a preferred ‘MDW NGINE™ Website’ module on s server or the NGINE™ server;

FIG. 43 illustrates an example of a diagrammatic view of a screen output of a NGINE™ Portal page illustrating a ‘Search Result Page’;

FIG. 44 illustrates an example of a diagrammatic view of a screen output of a NGINE™ Portal page illustrating an ‘'Offer Page’;

FIG. 45 illustrates an example of a diagrammatic view of a screen output of a NGINE™ Portal page illustrating the ‘Public Statistics Page’;

FIG. 46 illustrates an example of a diagrammatic view of a screen output of a NGINE™ Portal page illustrating the ‘Dashboard Page’;

FIG. 47 illustrates an example of a diagrammatic view of a screen output of a NGINE™ Portal page illustrating the ‘Vehicle Page’;

FIG. 48 illustrates an example of a diagrammatic view of a screen output of a NGINE™ Portal page illustrating the ‘Vehicle Inventory’;

FIG. 49 is an alternative embodiment of the flowchart of FIG. 9 illustrating a process of leasing or purchasing a vehicle on the server or the NGINE; and

FIG. 50 is a legend of the symbols utilized in the flowcharts.

### DETAILED DESCRIPTION OF THE PREFERRED EMBODIMENTS AND BEST MODE

The following detailed description includes the best mode and accompanying drawings in which like references indicate similar elements and which show specific embodiments and portions of a GUI interface for practicing the invention. The embodiments include optional and preferred embodiments to practice the invention which may be modified without departing from the scope of the invention as claimed. For example logical, mechanical, electrical, functional and system changes can be made in implementing the invention without departing from the invention. The following detailed description including best mode is not to be taken in a limiting sense, since the scope of the invention is defined in the appended claims.

The invention provides an automated online system and method providing vehicle manufacturers and dealers a platform to market and trade their products/services to potential customers who are interested in leasing or buying a vehicle as well as transforming a manufacturing assembly line, vehicle maintenance and record keeping and resale value of vehicles maintained in accordance with the novel system. This system provides an optimization of the lease/purchase application process and all related services between the manufacturer/dealer making it more efficient. The customer and third party institutions participating in this process will maximize time management as the level of manual input into the portal is minimal. This is possible because of the unique algorithms and data already on the portal that can accurately auto fill the necessary information based on a small amount of input from the user.

The server or NGINE™ System is an internet cloud Software-as-a-Service (SaaS) based system accessible worldwide for all user through the Internet with an Internet capable device. The system is built with the capability to efficiently process transactions between a customer and product/service provider and involved third parties including but not limited to: insurance companies, warranty and service providers, registration offices, rental companies, logistic companies and bank institutions in an automated process. All transaction parties are connected in real time, changing the traditional time consuming method of business to an efficient and productivity maximizing, Internet based method. The server or NGINE™-System facilitates processes of transactions among the users of the system by providing with no limit a voice control feature for the navigation within the system and input of data; a VIN number scan method, which replaces time consuming manual data input of vehicle specification; verification of user by automated cross checking of the person with the scanned legal documents; automated bank approval process of a lease or purchase application; capability to accumulate analytical and statistical information.

The system is equipped with state of the art high security control to insure maximum protection of data by complying to Federal Risk and Authorization Management Program (FedRAMP) standards, providing all users the highest protection of their personal information and documents based on a high-level U.S. government clearance for cloud computing.

The system serves as a medium to cover the entire transaction from beginning to end and past the consummation of the transaction to after care services. These services include but are not limited to: marketing vehicles, consummation of lease/purchase transaction (including financing, insuring, and warranting), customer care pre, during, and post transaction, trade-in of used vehicles to certified dealers, workshop and maintenance services, asset management, employee management, providing statistics based on consumer behavior data and market trends, facilitating search for desired product (configured using said data), automated online loan applications and documents along with immediate bank approvals, payment transaction facilitator, insurance policy access, automated vehicle registration, workshop services with pickup and delivery convenience along with loaner car coverage. Essentially, retailers market and deliver their products and services through this portal all the while managing their internal processes, while consumers search, purchase/lease, finance, insure, warrant and arrange for service on their vehicles all through the same medium allowing for efficiency and economical savings.

A unique secure identification verification process is completed for users (individuals or business entities) before granting access to the system. The security features are adapted to meet/exceed all requirements for each affiliated company within system.

The system's capability to convert data into relevant statistics for all the parties in the transaction benefits the consumer and business alike. While consumer's access market trends, model and brand rankings, and reviews, the business accesses statistics related to their sector enabling them to improve the quality of their products and services while increasing their competitive advantage. At the same time, the statistics provided to NGINE™ Tool manufacturers can lead to changes in the production line to increase the quality of the product to exceed safety standards and meet the market demand. The system uses a processor alone or together with Fuzzy Logic Processor to accept and filter out bids, and an iterative process to make certain each bid is the best available bid in the allotted time. The Fuzzy Logic Process also filters out irrelevant data and improves the accuracy and reliability of the statistics provided. This process is particularly advantageous in processing data on major and minor accident reports, insurance data on accident estimates on setting insurance premiums and incident reports and service difficulty reports as well as data from the end user which is correlated and used to transform manufacturer assembly line systems and components to produce safer and more reliable vehicles.

The invention is applicable to all types of vehicles having an engine. Vehicles, whether they are automobiles, airplanes, boats, trucks or construction equipment, all have accidents and incidents that are reported through government mandated reports by various agencies for example FAA, NTSB or incidents or service difficulties or insurance accident claims which are included in databases. The invention utilizes these databases as will be described hereinafter in greater detail as it pertains to automobiles with the understanding that the invention applies to all types of vehicles.

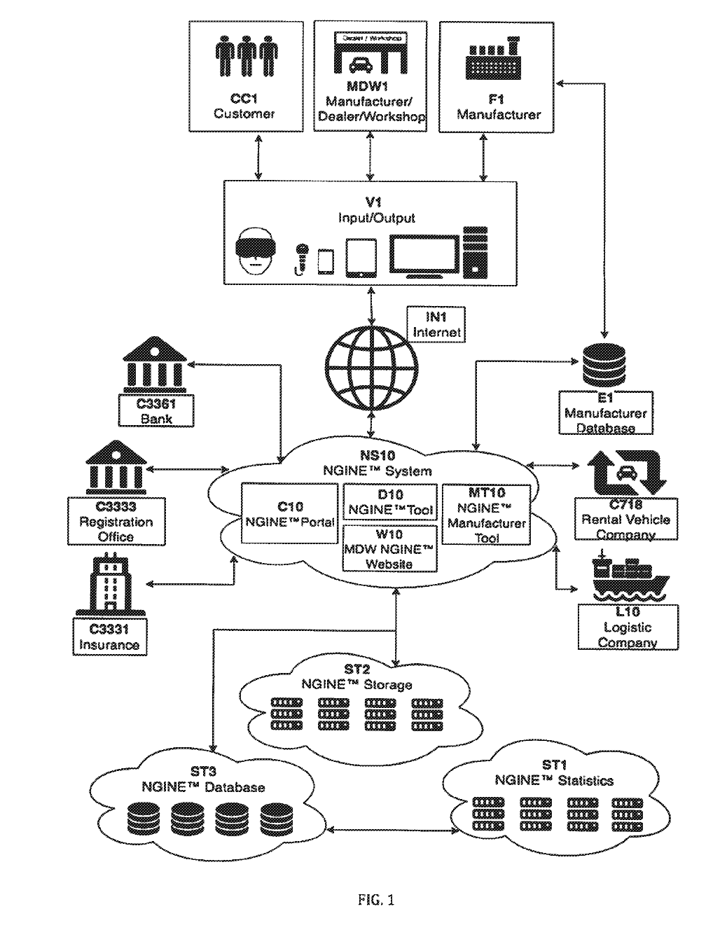

Referring now to FIG. 1 the novel server NS10 is illustrated in its best mode as a cloud Software-as-a-Service (SaaS) based system having a C10 user access portal with a manufacturer, dealer workshop D10 tool having a display of the manufacturer and dealers website W10 with a manufacturer tool M10. The novel server NS10 is connected to the internet IN1 to provide a worldwide connection to at least one manufacturer F1 having a plurality of vehicles. The novel system interacts with customers, dealers, insurance companies, registration offices, banks and logistics companies.

The novel server NS10 is also connectable to the internet IN1 through a variety of client computers which can be personal computers, smart phone, tablet or other electronic device providing an input or output of data through a keystroke device or a voice command, a virtual reality device represented by a face a goggle in V1, or other input device as indicated by V1. The client computer V1 is connected through the server NS10 used by a customer CC1 to search for a lease/sale/trade/swap or otherwise transfer a vehicle to a certified registered dealer in the NGINE™ System such as MDW1 who can advertise/lease/sell/trade/swap or otherwise transfer new or used vehicles.

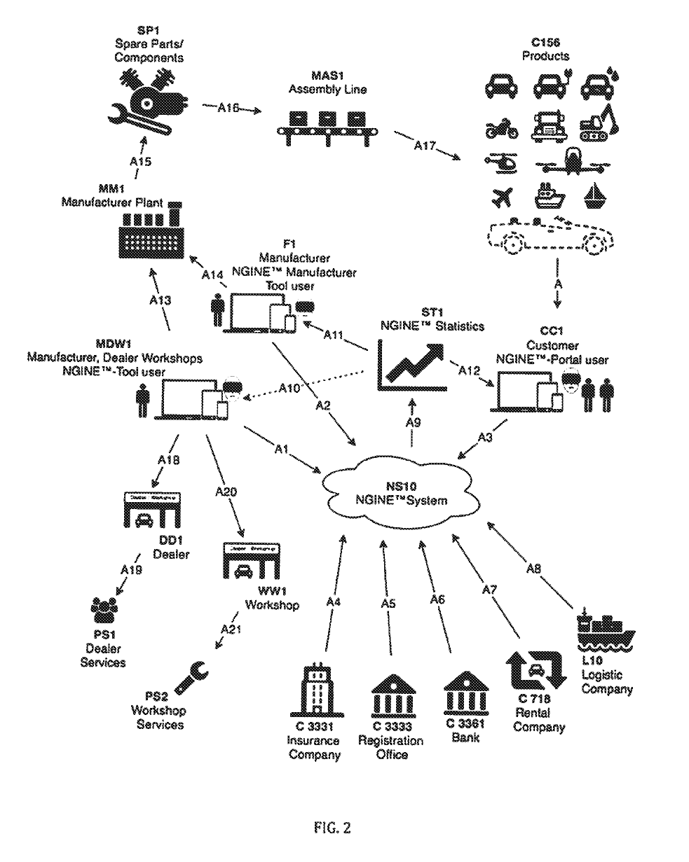

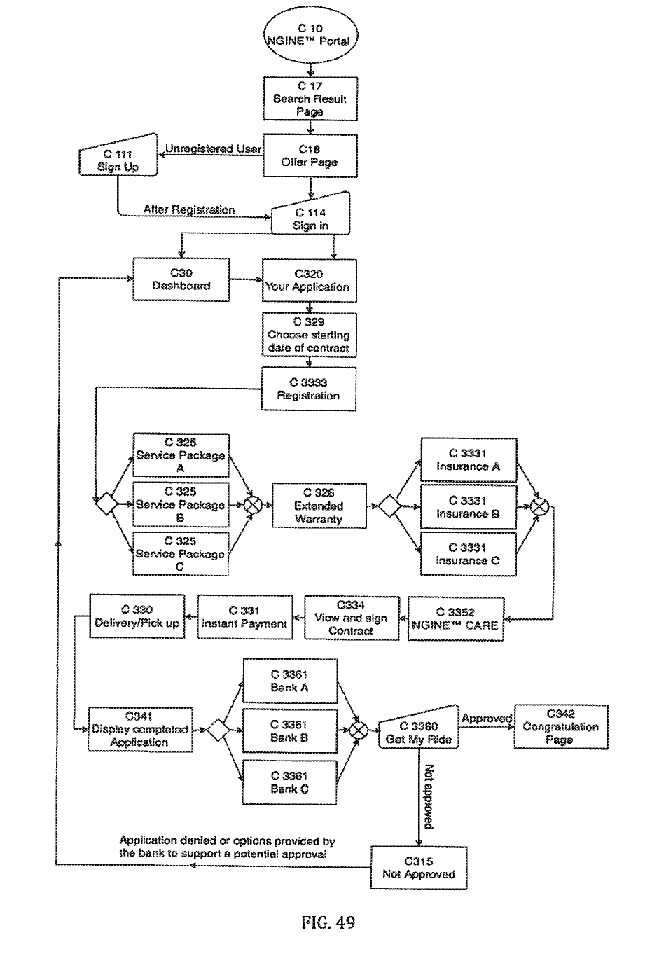

Referring now to FIGS. 1 and 2 the server NS10 is connected horizontally to at least one manufacturer F1 of a plurality of vehicles or products C156 and is connected vertically through the server to each entity required to complete the transfer of the vehicle. For example NS10 is connected to bank C3361 by hot link A6 to evaluate a lease or purchase application. This vertical link A6 connecting Bank 3361 to server NS 10 includes a plurality of horizontal links in the vertical link A6 that can include other financing options such as the manufacturer, credit union or other financing source so that when a particular service, such as here financing, is selected the sources of financing represented by C3361 can provide bids to customer CC1 or the novel NGINE™ can select the best possible bid in an iterative process as will be hereinafter discussed with reference to FIG. 49 that continues while other vertical transactions are completed that are necessary to complete the transfer such as obtaining insurance C3331 through hot link A4 and registration C3333 by hot link A5 all of which have a plurality of vertical links. In all cases each vertical transaction or link necessary to complete the entire transaction as well as the sale of the user's vehicle are completed. As will be discussed later the plurality of horizontal links make certain the best bid or the best combination of bids for servers are selected to complete the transaction within the time allotted by the user.

The server or novel NGINE™ system NS10 includes a ST2 database storage of all pictures and documents uploaded by the user or customer CC1. Database storage ST2 is connected to database storage ST3 which stores all data transactions involving users of the server or NGINE™ system. All transactions stored in the database storage ST3 are transformed into statistical information by a processor which can be a Fuzzy Logic Processor which processed data can be made available through the server and stored by the manufacturer in the manufacturer database E1. The manufacturer database E1 includes data on vehicle transferred, components of vehicles transferred and be used in conjunction with the manufacturer/dealer/workshop MDW1 to include vehicle service history, warranty information accident and repair information and other such data useful in evaluating the vehicle when the lease on the vehicle expires or the user desires to trade or transfer an existing vehicle. The server NS10 also links the MDW1 through link A7 to car rental or vehicle loaner sources C718 so that when the vehicle is immediately required pending delivery or in an accident or in for service a transportation option is provided using the novel server or NGINE™ server.

The novel server NS10 is connected to a logistic company L10 which provides delivery of the vehicle as soon as all paperwork transactions are completed for the delivery of the vehicle. The logistic company L10 can arrange delivery from a domestic factory or from a factory in a foreign country where the selected vehicle and components are specifically to selected and customized or from across the city from a dealer depending on availability on the options and components selected. The novel server or NGINE™ server due to its link A8 which is preferably a hot link which automatically provides a delivery date from the logistic company L10 as soon as the selection is complete and all necessary paperwork transactions are completed.

Manufacturer database E1 also can include the entire technical specifications of each vehicle produced including its components and subcomponents as well as components specifically selected by the customer such as tinted glass, bulletproof glass, special tires as well as customized features included by specialty shops such as conversions from a car to a convertible or a car to a limousine even where such options were not available in the normal production line. Data from the E1 database can include new models and new options which are made available to the customer or user CC1 through server NS10. This transforms the manufacturing and assembly line into an advertising and public relations advantage in planning the introduction of new modules and features based on actual consumer or user preferences rather than assumed preferences. Vehicles transferred are preferably uploaded from E1 to the NGINE™ server by scanning a barcode or QR code containing the VIN number of for example an automobile or a serial number of an aircraft or a manufacturer's ID number for other types of vehicles. In the future if a customer or end user wants to advertise a vehicle for trade in all the data from E1 based on the vehicle from the manufacturer and data including accidents, repairs and service from MDW1 can be made available so that the customer or end user gets the best price from the vehicle rather than having to rely upon an estimated value from trade publications.

The manufacturer database E1 preferably includes statistical and analytical information resulting from the interactions and transactions among all the users of the novel server including without limitation vehicles advertised, proposed new introductions of vehicles, the fluctuation and popularity of its products and other products of similar manufacturers, quality and services provided by MDW1 workshops, accident report, reports from insurance companies C3331, consumer special request for individualized customization of vehicles and their comparative reliability, consumer complaints and vehicle service providers from MDW1 to determine the quality of components to allow the manufacturer to transform their production line at the earliest possible time to enhance the quality and safety of their products.

Referring again to FIGS. 1 and 2 the novel server or NS10 system includes a horizontal link A between the customer or end user CC1 to a plurality of different types of vehicles C156. Using the NS10 server CC1 has an open link to a variety of vehicles including boats, planes, helicopters, UAVs, motorcycles, trucks, heavy equipment and automobiles including conventional electric and hybrid. Links to the NS10 NGINE™ server include an A1 link to MDW1 workshops in which CC1 can through link A3 obtain access to the manufacturer dealer workshops to review vehicles listed, displayed or advertised and purchase or lease a vehicle view maintenance and repair services and arrange workshop services, such as repair, attend to scheduling maintenance with a dealer branch. DD1 through a link A18 and schedule dealer services PS1 through link 19 and where the quality of workshop services P52 are linked by links A21 to workshop branch WW1 to MDW1 to manufacturer plant MM1 through links A20 and A13. Manufacturer plant MM1 gathers information from MDW1 to enhance and improve quality control through the manufacturer tool user F1 which is linked to the manufacturer through link A14 to a statistical database ST1 through link A11. The statistical database ST1 is linked to server NS10 by a link A9 which in turn is linked to consumer user CC1 through a link A12. MDW1 can upload their products and services which can be marketed on the server NS10. The manufacturer dealer workshop can be used to manage employees, interact with customers, provide workshop services with other NGINE™ dealers and trade vehicles between dealers as well as with private NGINE™ customers or users as will be described hereinafter in greater detail.

Data in ST1 is in the preferred embodiment also collected from accident reports both state and federal as well as insurance reports from C3331 through link A4 which is connected to server NS10 through link A9. Statistical database ST1 is connected to MDW1 through link A10 as well as the manufacturer tool through link A11 as well as link A14. Manufacturer plant MM1 is linked to spare parts and components SP1 by link A16 so that when data from ST1 which includes without limitation data from fatal accident reports, accident reports, incident reports, insurance reports, service difficulty reports, service life, dependability reaches a predetermined threshold a component in SP1 is used to replace a previously used component in assembly line MAS1 by a link A16 which replaced component is put into new products such as in the dotted lined convertible in C156 through a link A17 so that not only can consumer or user CC1 know if a new product has a suspect component but the manufacturer can replace a questionable component at the earliest possible time and limit liability while providing safer vehicle to consumer or user CC1. In the preferred embodiment ST1 includes not only a processor alone or together with a Fuzzy Logic Processor with a fuzzy relational database so that when data from a plurality of sources reaches a fuzzy threshold components SP1 are changed in assembly line MAS1.

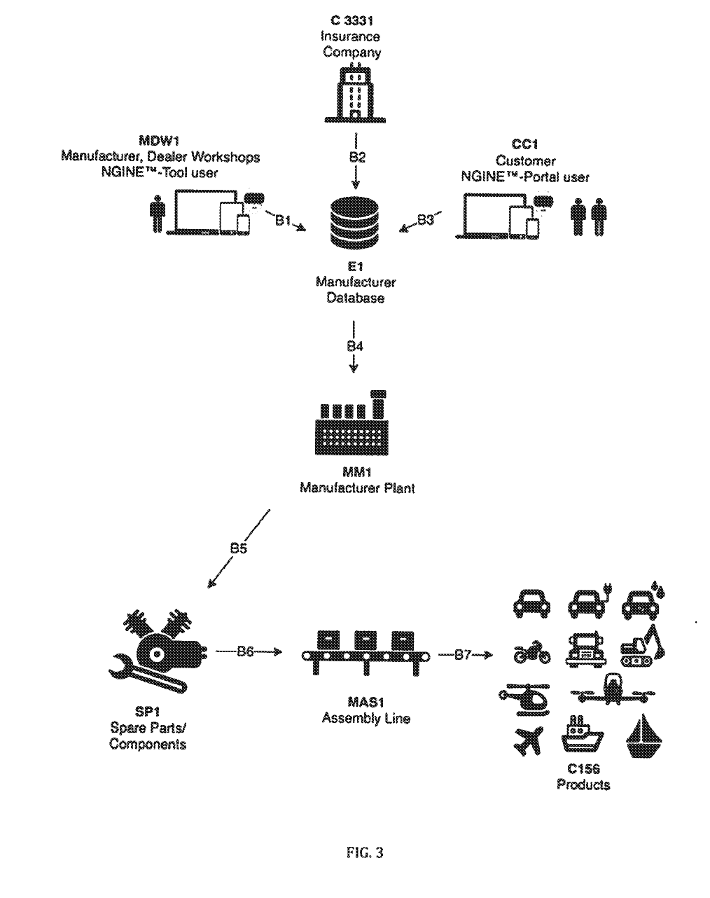

Referring without limitation now to FIGS. 1 and 3 interactions between the manufacturer dealer workshop MOW1 including without limitation advertised vehicles fluctuation and popularity of existing and proposed new products, quality of parts, components, accident, incident and service difficulty reports including insurance claim reports are included in manufacturer database E1 and are linked to E1 by link B2 from insurance company B2 manufacturer dealer workshops MDW1 and consumer portal CC1. These reports including reports from federal and state reporting agencies including the FAA and NTSB are processed in the novel server and linked by a combination of hot and cold links B4 to the manufacturer plant MM1. Hot links are preferably used when an accident involves a loss of life.

The data processed by the server or NGINE™ server including special consumer requests for specialized components and/or modifications not provided for in the ordinary production line such as limousines and in some cases moon roofs and convertibles are gathered together and linked to the assembly line MAS1 and spare parts and components SP1 through links B5 and B6 to result in a transformation of new products C156 available to the end user or consumer CC1.

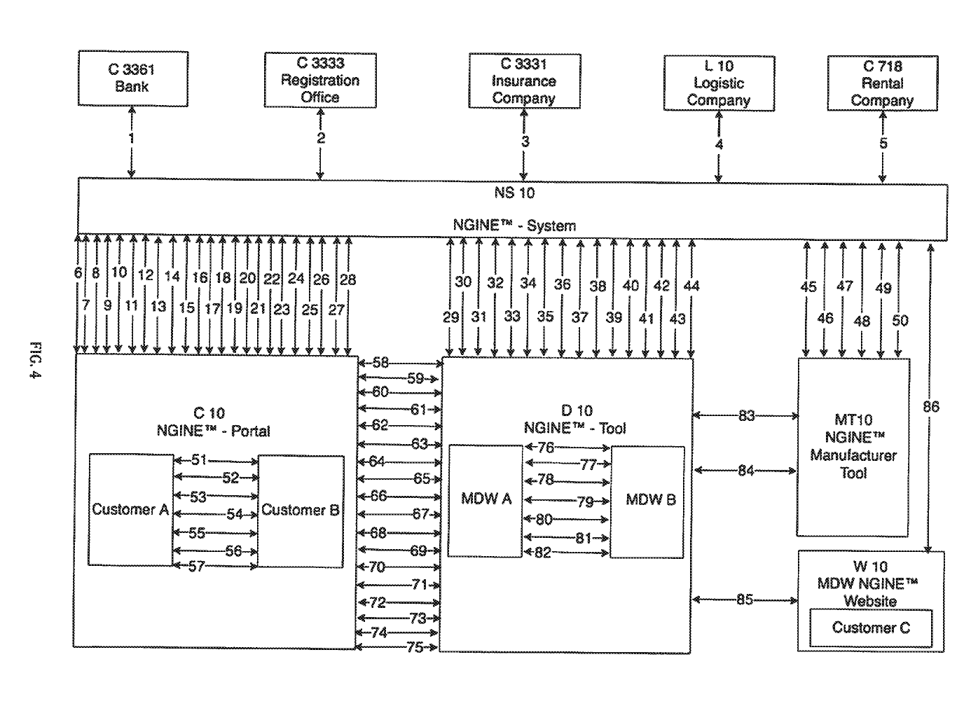

Referring now to FIGS. 1 and 4 inputs/outputs or transactions in the best mode in the server or NS10 NGINE™ server is illustrated with input/output 1, 3, 4, and 5 to bank C3361, registration office C3333, insurance company C3331, logistic company L10 and rental vehicle company C718 respectively. The server NS10 includes a customer or user portal C10 a dealer D10 tool a manufacturer MT10 tool and a manufacturer website W10. These portals or tools are linked together with a plurality of inputs/outputs through novel server NS10. More particularly dealer tool D10 provides a tool for the manufacturer, dealer and workshops to advertise their vehicles and services. In the preferred embodiment as illustrated in FIG. 4 the manufacturer tool MT10 allows the manufacturer to oversee all activities of their franchisees operating worldwide. In the preferred embodiment this area is accessible only to the manufacturer.

A customer or user C10 accesses server NS10 through a sign in input 6 by obtaining or using a user name or password to obtain access 7 to browse all public area features. Server NS10 provides a change or forget password input/output 8. An affiliate input/output 9 gives the customer or user the ability to place or advertise a product or service of the MDW10 on their website, blog or social media tool. Link 10 allows a customer to pay for vehicles or services by credit card, pay pal, apple pay or obtain financing from a financial source or a bank C3361. Input/output 11 allows the user C10 to upload documents for example lease/purchase application, ID card, driver's license etc. Input/output 12 starts the lease/purchase or service window after the user completes the entry of personal information. Input/output 13 allows a customer to design a lease/purchase transaction for a vehicle, change existing insurance, select a maintenance package, view contract terms or conditions or otherwise manage a vehicle. Input/output 13 provides statistical data on model popularity, maintenance records, price comparisons, operation costs, gas mileage, maintenance costs and any other data other owners reports and comments as well as consumer reports to allow a consumer or user to make an informed selection.

Input/output 15 provides for the trade in of a vehicle by providing a VIN number and mileage to receive a suggested market value to offer a previously owned vehicle for sale or if it was a previously obtained NGINE™ vehicle all manufacturer information, identification of factory installed components or their replacement maintenance and service records and all other data stored on the NGINE™ server relevant to the actual value of the vehicle.

Input/output 16 provides a personal short list of vehicles previously. Input/output 7 allows a consumer or user to search for available parking for a selected vehicle such as parking spaces, airport hangar space or boat or ship docking facilities.

Input/output 18 allows a user to seek fractional ownership or shared ownership of a vehicle with other customers or users that may be interested in the same vehicle or sharing or renting or riding in the vehicle. Input/output 19 indicates locations for fuel/electrical charge or hydrogen stations or other fuel suitable for the selected vehicle and input/output 20 provides a search service for the physical locations of stations listed on input/output 19.

Input/output 21 provides public statistics based on vehicles searched, leased or purchased, tabulated with a NGINE™ Score Index (NSI) while input/output 22 allows a user/purchaser to access scores from the NSI index Which includes customer/user feedback for a selected vehicle. Input/output 23 records a customer user's search history and input/output 24 provides a vehicle history of all vehicles leased or purchased by the customer. Input/output 25 provides an online leased vehicle return process and input/output 26 provides a general help resource.

Input/output 27 provides a customer care resource as well as links and assistance to technical problems with the vehicle, roadside service or urgent medical issues. Input/output 28 provides a member points portal for collecting points and rewards for customers and users using the NGINE™ system.

Input/output 29 is a sign up process for MDW10 to sign on to the server NS10. Input/output 30 includes a sign in/sign out option with a password or user name. Input/output 31 provides an option to obtain or change a password and input/output 32 allows MDW10 to create and manage invoices for vehicles purchased/leased or for products or services provided. Input/output provides NSI statistical information on trading workshop services, vehicle transfers, bills, point of sale (POS) data, employees, reviews and reviews of vehicles, products and services. Input/output 34 allows MDW10 to oversee activities, evaluate productivity and employees and view statistical information collected by the novel server or NGINE™ system.

Input/output 35 allows dealers D10 to upload vehicle technical specification so that they are available to the consumer C10 portal. Input/output includes an advertised best deal by a dealer D10 and input/output 37 provides for advertising of maintenance service packages and input/output 38 provides an advertising planner for scheduled events or for sharing on social media platforms and input/output 39 provides a discount planner. Input/output 40 provides an inventory management tool to oversee changes in vehicle inventory and input/output 41 include an option to import and export vehicles worldwide.

Input/output 42 provides a customer management tool to track vehicle information and customer contact information and statistics in import and export data on vehicles and input/output 43 provides for payment by bank transfers, credit card and all other forms of payment. Input/output 44 provides setting options for building or changing a website based on provided options.

Input/output 45 provides for the manufacturer MT10 to register and obtain access to the novel server NS10. Input/output 46 provides for signing in or signing out or obtaining a user name or password. Input/output 47 provides for a change of password or steps for retrieving a forgotten password. Input/output 48 allows the manufacturer to create and manage invoices for products and services and input/output 49 allows the manufacturer to advertise or showcase new products models, news as well as concept vehicles. Input/output 50 provides statistics to the manufacturer MT10 data on the popularity of particular vehicles as well as comparative data of other manufacturers vehicles.

Input/output 51 allows different customers or users to communicate with each other to provide number plate reviews which show the owner of the commented number plate. Input/output 52 provides questions and answers and information shared by users of particular brands and models. Input/output 53 provides customer user information about particular brands and models in which a customer or user can deny access for being contacted directly. Input/output 54 allows customers and users to share their experience with the server or NGINE™ server NS10 and input/output 55 allow users to comment on reviews. Input/output 56 provides an option for shared or fractionalized ownership among customers or users including a ride sharing center. Input/output 57 provides an option to advertise lease offers for parking spaces, airport hangars, ship docking or other available facilities.

Input/output 58 allows MDW10 to communicate directly regarding concerns related 117 to interactions on the server NS10. Input/output 59 allows a customer and the MDW10 to comment and respond to displayed comments. Input/output 60 allows the customer and MDW10 to comment and respond on models, brands, products and services and input/output allows the user to search vehicles while input/output 62 allows the customer to evaluate a vehicle offer including vehicle technical specifications, pictures and videos. Input/output 63 provides for the arrangement of a test drive and input/output 64 provides a pick up delivery service after a lease/purchase agreement has been concluded or to pick up or drop off of a vehicle for maintenance.

Input/output 66 allows a customer to select a vehicle and start the process of purchasing/leasing or otherwise provide for the transfer of a vehicle. Input/output 67 provides a made to order option to customize a vehicle or find a vehicle that meets their specific needs. Input/output 68 allows a customer/user to book maintenance and input/output 69 allows the customer to submit desired workshop requests and receive bids in which the customer can select the lowest bid or have a fuzzy logic processor in the novel server or NGINE™ server NS10 to select the best bid while filtering out bogus bids. Input/output provides access to complete vehicle maintenance records. Input/output 71 allows a customer or user to obtain trade in value of a particular vehicle using a VIN number to receive a more exact trade in value using the Fuzzy Logic Processor which can be compared to other market value estimates such as Blue Book value. Input/output 72 provides a payment portal for services and products and input/output 73 provides a tool to create and manage invoices for products and services. Input/output 74 provides details for withdrawing a contract or returning a vehicle under the applicable laws as well as arranging for the return of a vehicle at the end of a lease. Input/output 75 includes a profile of MDW10 of the products and services available. A customer can search for a specific MDW10 to review their offered products and services.

As between two different manufacturers/dealers MDWA and MDWB input/output 76 allows one certified dealer to swap vehicles. Input/output 77 allows the dealers to trade their products internationally. Input/output 78 allows dealers to communicate with one another regarding concerns and input/output 79 allows dealers to evaluate reviews of other dealers. Input/output 80 allows a dealer without a particular type of workshop, for example painting, to book the work at another workshop. Input/output 81 allows a dealer without workshop to deal with other workshops or independent workshops. Input/output 82 provides for payment using a wide variety of bank, credit card, check or other ordinarily accepted payment.

Input/output 83 provides a tool for the manufacturer and dealer to display and advertise vehicles and services as well as optionally sharing of informational statistics between dealer D10 and manufacturer MT10 such as expenses, top selling vehicles, employee quality, performance and inventory statistics, profit and loss, customer satisfaction and other such data and information. Manufacturer MT10 tool allows the manufacturer to oversee activities worldwide and is an area accessible only to the manufacturer. Input/output 84 provides data on inventory and inventory changes related to cities, states and countries. Input/output 85 provides for a website tool for both dealers D10 and manufacturers MT10 to display data and information on vehicles, products and services available to all customers C including customers A and B. Input/output 86 connects MDW10 to the novel server or NGINE™ server NS10.

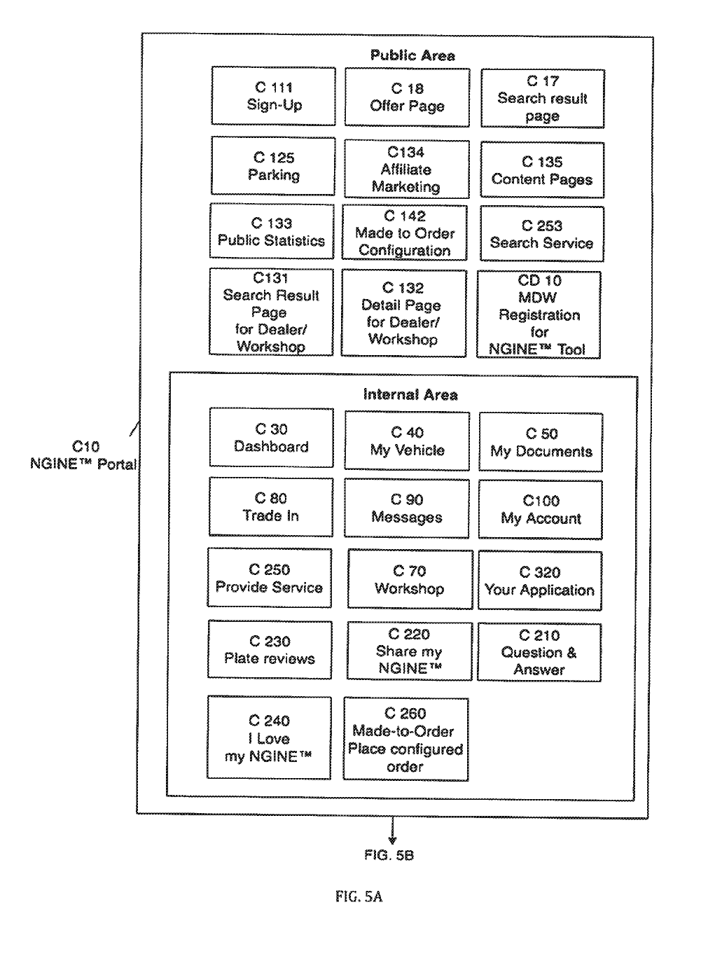

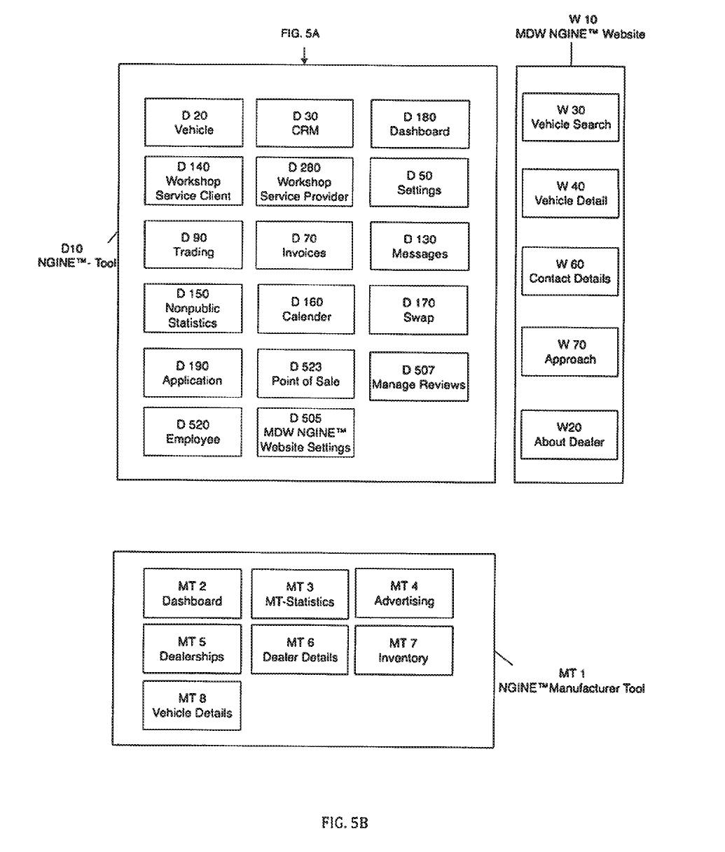

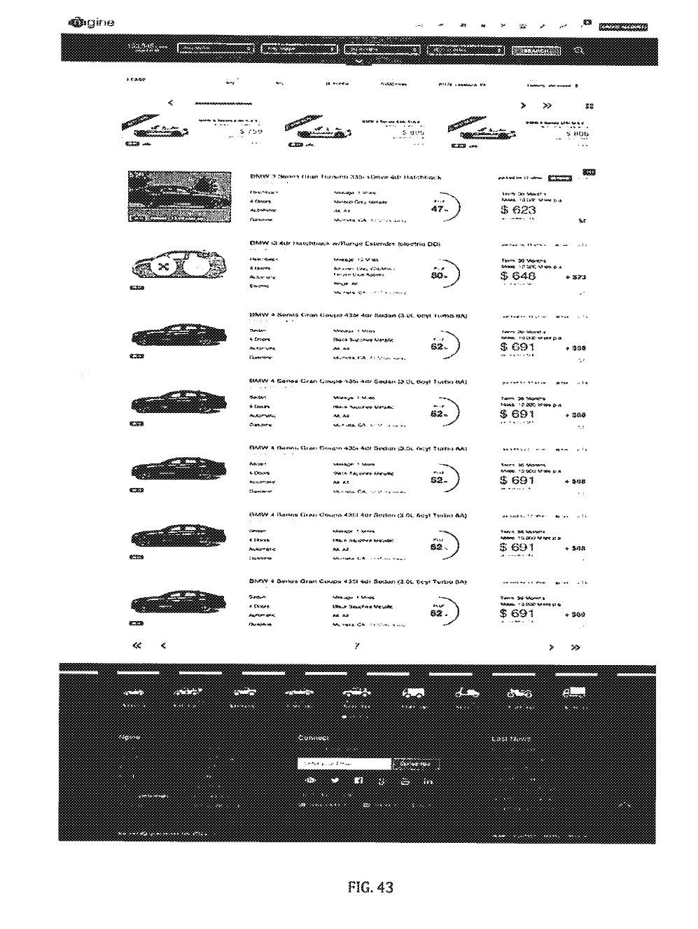

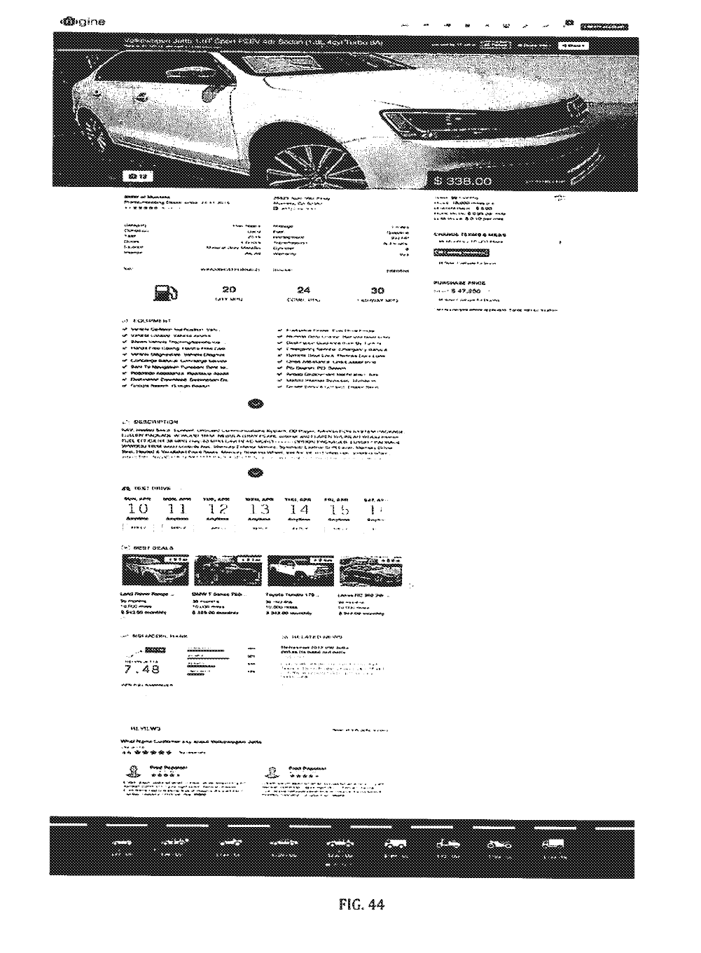

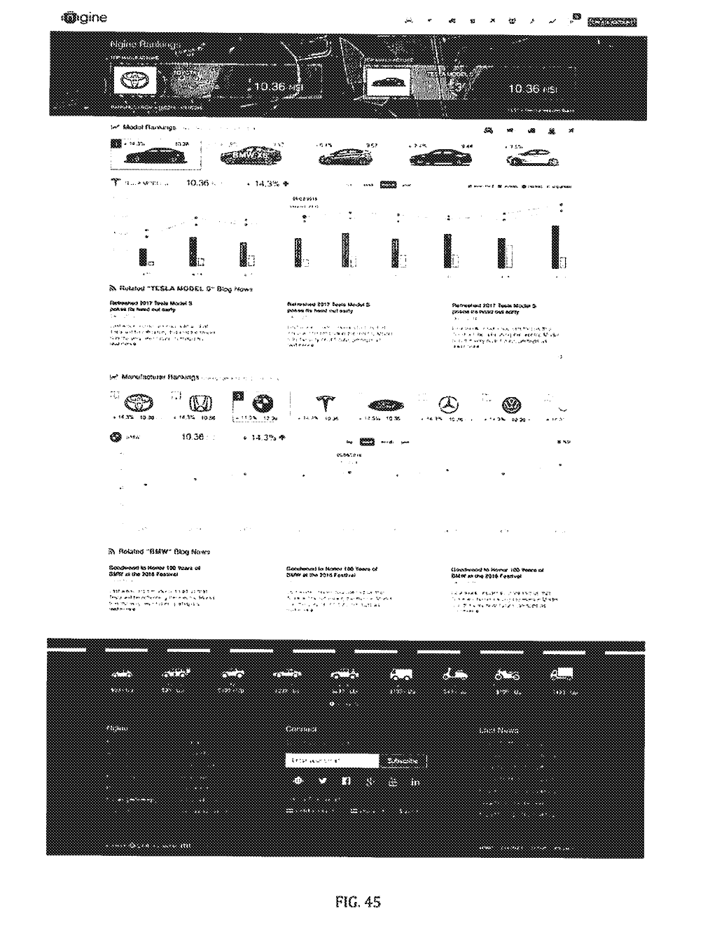

Referring now to FIGS. 1, 5A and 5B the public and internal portions of the customer or user module C10, dealer D10 module and manufacturer MT10 module is illustrated. The public portions of C10 module include a sign up or sign in module, an offer module, an example of which is illustrated in FIG. 44, a search results module C17, an example of which is illustrated in FIG. 43, a parking module C125 which provides a personal shortlist of selected vehicles for review or to start a lease/purchase application at a later time. Affiliate marketing module C134 displays the terms and conditions for an affiliate associate. Contact module C135 includes landing pages, help center, contact, sign in, prices for dealers and workshop, press, blog, terms and conditions, privacy information and homepage and other such contents. an example of which is illustrated in FIG. 45

Public statistics module C133 an example of which is illustrated in FIG. 45 includes statistics for brands and models of vehicles with parameters such as searched, viewed, parked, unparked, selected vehicle for lease/purchase application and lease/purchase application approval. Made to order module C142 includes the option to customize a desired vehicle based on personal or desired requirements. Search service module C253 provides the option for searching services such as aircraft hangar or vehicle or ship parking places, gas, hydrogen or electric charging stations or any other vehicle related services. Search results module C131 displays results for dealers, workshops that can be searched by zip code or a given radius around a particular area. Detail module C132 provides detailed information about a dealer or workshop with information such as contact information, hours of operation, sales, list of reviews, best deals, maintenance offers and the like. MDW registration module CD10 displays information about the novel server or NGINE™ server and terms and conditions for its use.

The internal area of customer or user C10 portal includes a C30 dashboard module Which includes selected vehicles for lease or purchase, start an application for lease/purchase, view status of ongoing or processed application, display of last searched history, view of maintenance offers and search information pertinent to the customer or user. My vehicle module C40 includes a history of all vehicles purchased on the server NS10, data on insurance, maintenance history, warranty and contract data on lease/purchase agreements. My documents module C50 includes documents related to the vehicle that can be viewed, edited or deleted. Trade in module C80 is a portal where trading of vehicles can be started or completed. Message module C90 is a message area for all sent and received messages or to start or respond to a conversation. My account module C100 includes the customer or user's personal information such a payment data, membership, avatar, password, vehicle care and maintenance data.

Provide service module C250 allows the customer or user to provide and search for all types of services related to vehicles. Workshop module C70 provides the option of searching for a particular workshop or request a particular type of service for a vehicle. Your Application module C320 requires the uploading of required documents that will be stored in C50, review selected vehicle specifications, decide for terms and miles, request registration of a vehicle, select insurance, financing, warranty, request delivery, select method of payment, complete a lease/purchase contract including an e-sign of agreements.

Plate review module C230 provides a write nd review platform. Share my NGINE™ page C220 allows users to share in fractionalized ownership, offer available shared ownership, rent or advertise seats available for long trips. Question and answer module C210 allows users to exchange information about vehicles, products and services and about the NGINE™ system. I love my NGINE™ module C240 allows users to share their experience on the NGINE™ system using their vehicle and module C260 allows users to place an order or lease or purchase a customized vehicle.

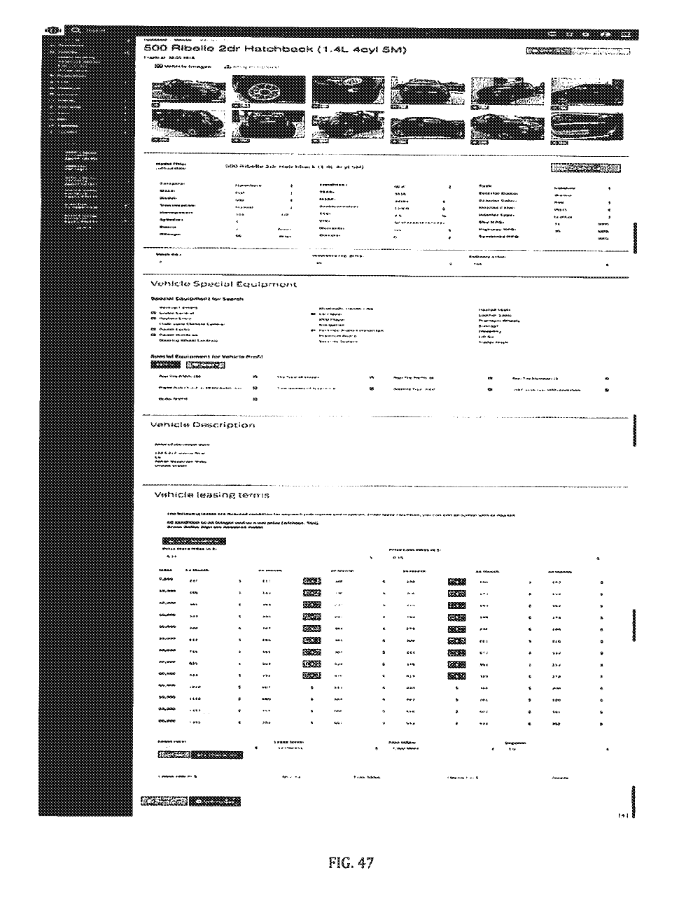

Dealer tool D10 includes vehicle module D20 which allows manufacturers and dealers to upload technical vehicle specifications on the server NS10. Vehicle identification information can be uploaded manually or by scanning a barcode or QR code or preferably by VIN numbers, options, suggested terms and conditions for lease/purchase and other dealer manufacturer information can be included. CRM module D30 allows a dealer to manage existing customers and oversee all lease/purchase contracts, add and delete customer information. Dashboard module D180 provides a database for the dealer or manufacturer to provide a list of all vehicles and models manufactured and available vehicles, the amount of customer interest on a particular vehicle, sales, profit and loss and other vehicle data, an example of which is illustrated in FIG. 47.

Workshop module D140 allows the dealer to book maintenance or a list of jobs for workshop services. Workshop provider module D280 provides workshop services and packages for advertisement for customers and to use a dealer NGINE™ tool to work with other dealers as a resource for services. Settings module D50 allows the dealer to manage their account with such things as manage reviews, notifications, invoices, billing, payments, employees and point of sale (POS). Trading module D90 is a trading area where a dealer can trade vehicles advertised by a customer. Invoice module D70 allows the dealer to manage all invoices. Messages module D130 provides access to sending and receiving all messages and communicating with customers and manufacturers. Non public module 150 provides statistical and analytical data on lease/purchase applications, trading, workshop services, transfer of vehicle, transactions, point of sale (POS), employees, reviews of providers of services with access limited to administrators.

Calendar module D180 is a display short cut option for the dealer to provide data on “All vehicles”, “advertised vehicles”, “all customers” “new leads”, “new messages”, “active Application”, “leased vehicles”, “sold vehicles”, “active trades”, “closed trades”, “active jobs”, “all employees”, “website clicks”, “credits” and statistics as to product popularity, to do lists and an activity stream as to customer's activity in relation to products and services. Swap module D170 allows swapping of vehicles with another dealer. Application module D190 displays all applications and their status. Point of sale module D523 displays added POS products. Manage reviews module D507 displays list of reviews. Employee module D520 displays employees and workload and work information. MDV website settings module 505 displays options for building or editing a website based on various parameters.

The manufacturer module MT1 includes a dashboard module MT2 can include data such as top 5 models sold, top 5 models NSI, number of vehicles sold per day, average total, inventory average per dealer, top 10 countries where vehicles have been sold, vehicle warranty data. Statistics module MT3 can provide statistical information about dealerships throughout the world such as the top 5 models, the top 5 models NSI, vehicles sold per day per country, salary, inventory, statistics profit per country, transportation costs, advertising statistics per country and statistical data on insurance, banks, registration offices, rentals, leases, fractional ownership data and logistic companies. Advertising module MI4 provides the option of advertising models and planned new models, vehicles and options.

Dealerships module MT5 can display all franchise dealerships, their volumes of sales and service provided along with dealer location and contact information. Dealer details module MT6 can provide data on particular franchisees, inventory statistics, advertising statistics, customer service statistics, profit and loss data. Inventory module MT7 displays changes in inventory per dealer, per country or per geographic area. Vehicle details module MT8 provides data on each vehicle type, its components, accident, incident and service difficulty reports per each model and each component as well as vehicles with similar components, customer complaints and availability of alternative components as well as fuzzy logic from NS10 as to changing a component or model when a fuzzy threshold is reached in the NS10 server database.

The novel server or NGINE™ server NS10 preferably includes a W30 module for displaying all vehicles available for transfer, a vehicle detail module W40 for providing detailed information on a vehicle displayed which is the same as displayed on the offer page C18 of the customer portal C10. The novel server NS10 includes a contact details module W60 to display general contact information about the manufacturer, dealer and workshops (MDW) that have worked on the vehicle. An approach module W70 displays addresses and directions to each MDW. About dealer module W20 displays all information about each dealer, a profile of their business and sales and contact information.

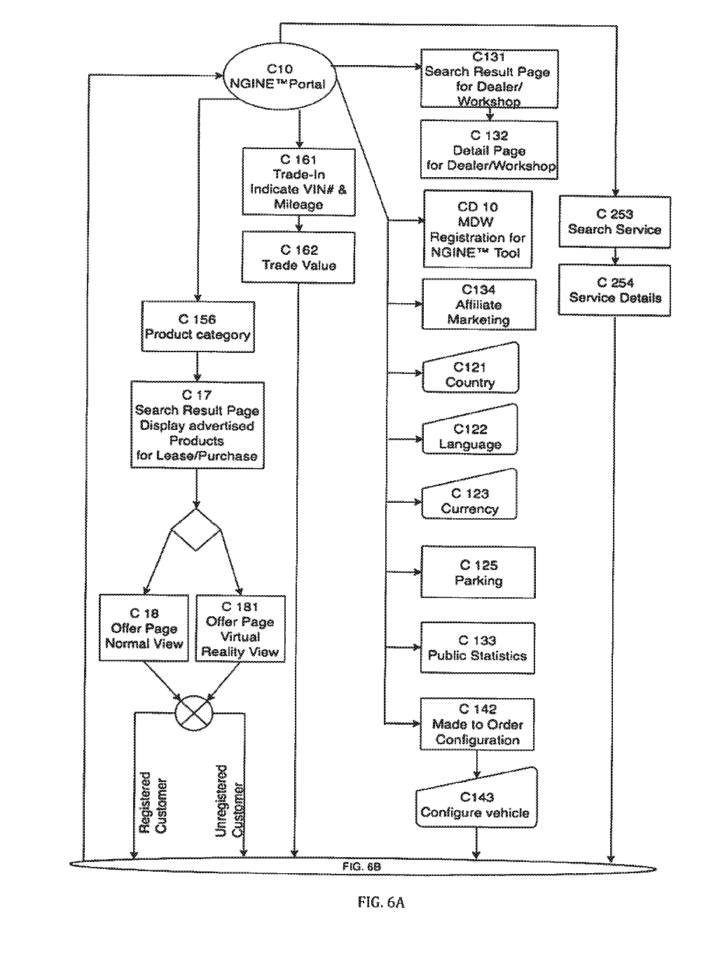

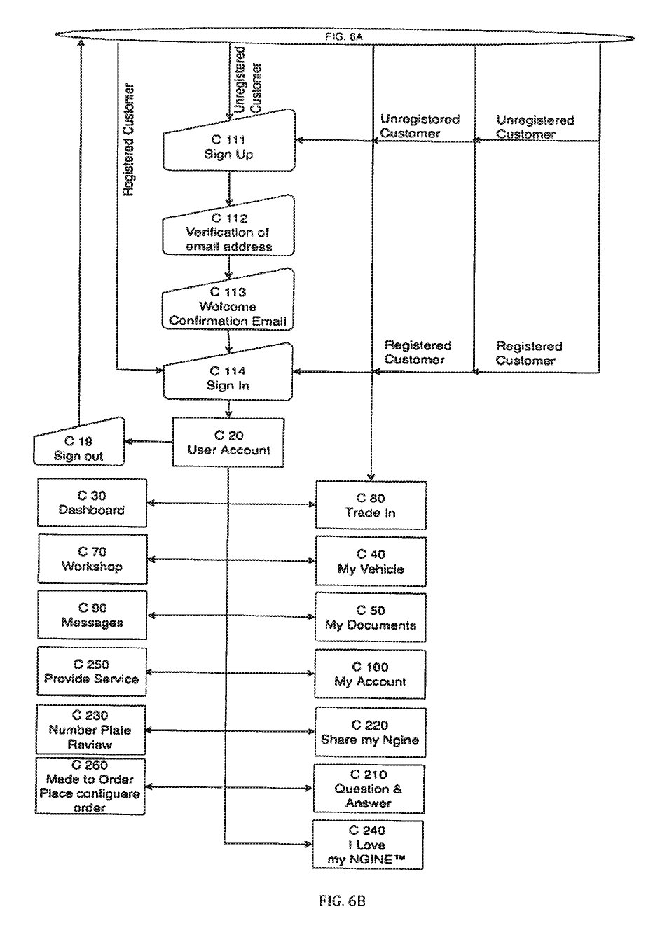

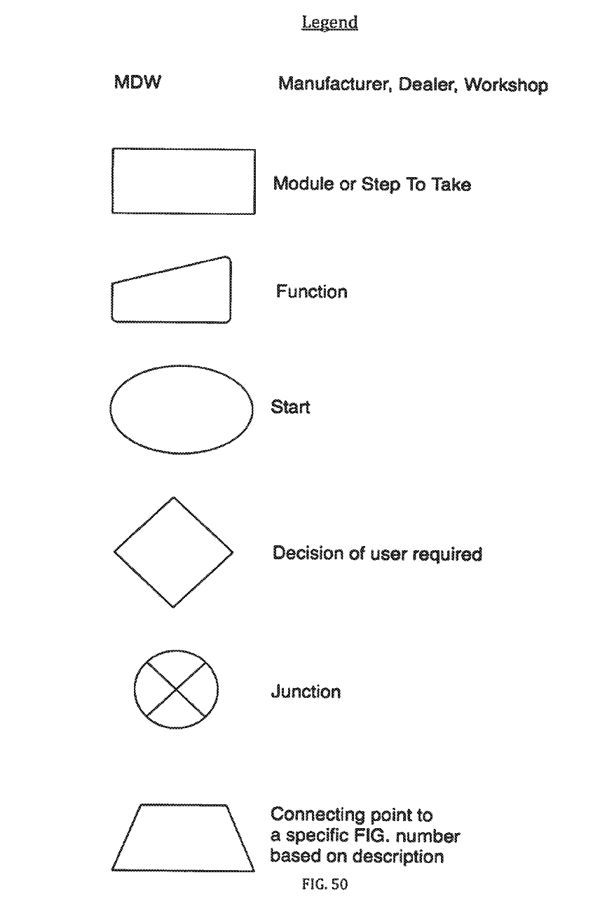

Referring now to FIG. 6A, 6B a block diagram view of the functional modules is illustrated for implementing the consumer or user portion C10 of the electronic system of the novel server NS10. FIG. 50 is a legend of the symbols used throughout the electronic system. The customer or user portion C10 includes a functional log in and registration module CD10, which allows a customer or user to sign in or register in sign in module C114 using a password or access code. Unregistered users are directed to sign up module C111 by verification module C112. Once verification is complete module C113 sends an email confirmation of the personal account.

In the registration process the customer portal C10 allows the customer or user to seek affiliate marketing in module C134 which displays the terms and conditions for becoming an affiliate marketing associate. A country module C121 requires the customer or user to enter a specific country's website at which time language module C122 changes the language to match the website as a default setting. Language module can manually be changed to a language other than the default language. Currency module C123 similarly uses the currency to match the specific country's website as a default setting which also can be manually changed. Parking module C125 provides time to complete the registration process.

Product category module C156 allows a user to start a search for a specific vehicle or search for all types of vehicles such as cars, electric cars, hybrid cars, trucks, buses, construction vehicles, ships, planes, helicopters, drones, etc. Select made to order module C142 to provide customization of a vehicle based on personal or desired features and provide manual inputs to module C143 to configure the vehicle. When a user decides to either lease or purchase a vehicle or has decided to purchase a specially configured model the user is directed to the user account module C20 to sign in/sign up or is directed to module C260 to process the vehicle order.

After an entry is made in product category module the search results are displayed in search result page C17 and offer page C18 module displays detailed specifications on the selected vehicle, pictures, videos, terms and conditions MDW contact information at which time the consumer or user can decide to select to purchase or lease or park in parking module C125 so that the list can be reviewed at a later time. Alternatively search result page C17 can display the results of the search in a virtual reality setting using virtual reality module C181 using a goggle input/output device as illustrated in VI in FIG. 1. Offer page module also accesses public statistics module C133 to provide customer reviews, model ranking, model review, model based related news, best deals with upselling options and book a test drive option. The customer user can open sign out module C19 to end the session or open the customer dashboard module C30 to view all selected vehicles for lease or purchase or start an application for lease or purchase or view the status of an ongoing or already processed application.

Trade in module C80 is opened if the customer has an existing vehicle to trade in or the lease/purchase of another vehicle. Alternatively trade in module C80 can be accessed where the customer does not want to purchase a vehicle by accessing trade in module C161 if an existing customer or by completing sign up module C111. In this case trade value module displays the trade in value of the vehicle. Alternatively if a previous or new customer after registration is only searching for service on a new or existing vehicle search service module C253 provides information and data on available vehicle services. Service module C254 provides a detailed description of available services.

User account module C30 provides links to the C40 module for the lease, purchase or other arrangements for the transfer of a vehicle module C40 service for the vehicle by accessing module C70 and provide all paperwork and legal documents necessary to transfer one or more vehicles by actuating my documents module C50.

Messages module C90 provides access to all sent and received messages including all paperwork and legal documents from documents module C50. Provide service module C250 is available to provide service with respect to a transferred vehicle or to search and enter into agreements for hangar space, dock space or facilities needed for a vehicle. My account module C100 includes the customer's personal information, NGINE™ CARE membership, avatar, password for accessing NGINE™. Personal account information is displayed and can be reviewed and edited. The NGINE™ server verifies personal information to validate the uploaded documents and the person with the uploaded documents.

As previously discussed module C230 provides for reviewing and writing feedback and comments on vehicle number plates. Feedback to a number plate owner will be shown only to the owner of the commented number plate. The system sees only the ranking of the number plate and not actual comments. Share my NGINE™ module C220 provides for services offered at a car servicing center or posting available seats for long distance transportation. Question and answer module C210 allows users to share and exchange information on vehicles and services and module C240 allows users to share experiences with other vehicle owners. Module C260 provides made to order vehicles configured to accommodate the special requirements or desired vehicle features and provides special made to order, leasing, pricing documents and requirements.

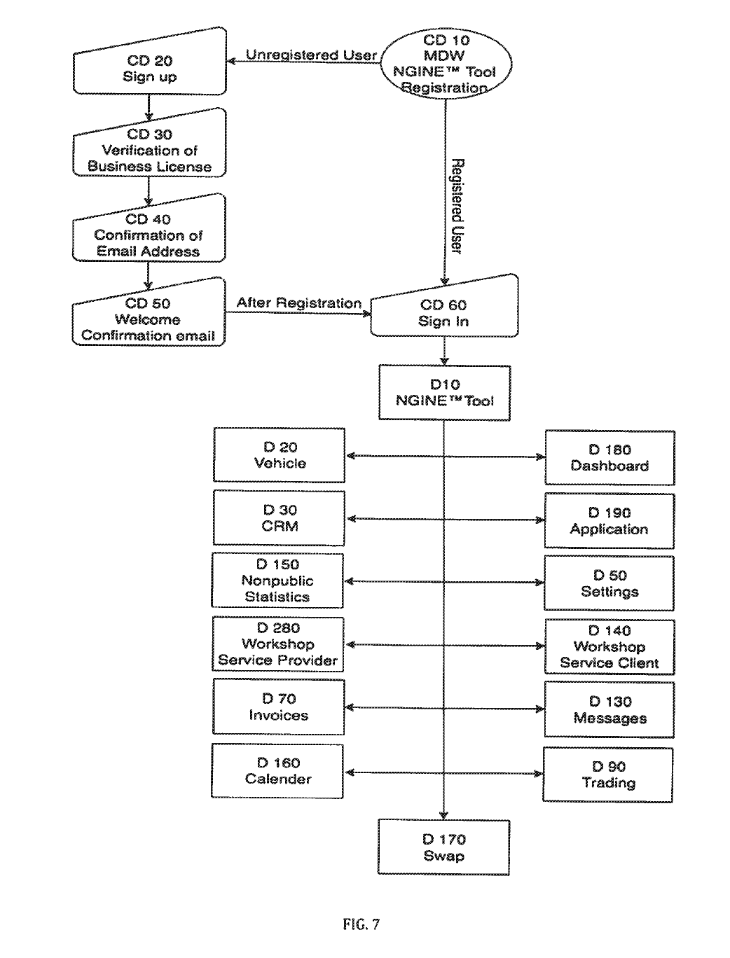

Referring now to FIG. 7 the novel server NS10 provides MDW registration to the novel server NS10 for MDW by which a MDW can register or sign in to register. Dealer module CD10 includes a sign up CD 20 module, a verification of business license module CD 30, an e-mail confirmation of business module CD 40 and a welcome confirmatory e-mail welcome module LD50.

Once registered MWD module includes a sign in module 60 and MWD module D10 is linked to a dealer D20 module. Dealer D20 module allows dealers and manufacturers to upload vehicle technical specifications and advertise and display vehicles for sale or lease as previously discussed. MWD module D10 links to a dashboard module D180 to provide data on all vehicles their status as well as lease/purchase agreements and their status as previously discussed. A customer relation module D30 provides an area where the dealer can manage all existing customers and oversee all offers for lease, purchase and edit customer information and oversee vehicle information contract terms, lease terms and schedule appointments with customers.

Application module D190 displays a list of all pending applications and their status in the approval process as well as detailed information on the customer and the specifications on the vehicle. Setting D50 module allows the dealer to change settings, manage reviews, track invoices, billing payments and other parameters as previously discussed. Non public statistics module D150 provides statistical and data on vehicle inventory as previously discussed. Workshop module D280 provides for the advertisement of general workshop services and networking with other dealers to supplement or add workshop services provided by other workshops as heretofore discussed. Service client workshop module D140 allows a dealer to book workshop services or list a job for workshop services as previously discussed.

Invoice module D70 provides a management tool for services provided including generating, tracking, managing and viewing all invoices as previously discussed. Messages module D130 provides a messages access for overseeing all received messages, respond or start a conversation as previously discussed. Calendar module D160 allows the user to schedule and oversee delivery, pick up, maintenance requests or schedule a test drive. Trading module D90 accesses the trading area where the dealer trade vehicles advertised by the customer as heretofore discussed. Swap module D170 displays a list of all applications and their status as well as detailed information on the vehicle and customers as heretofore discussed.

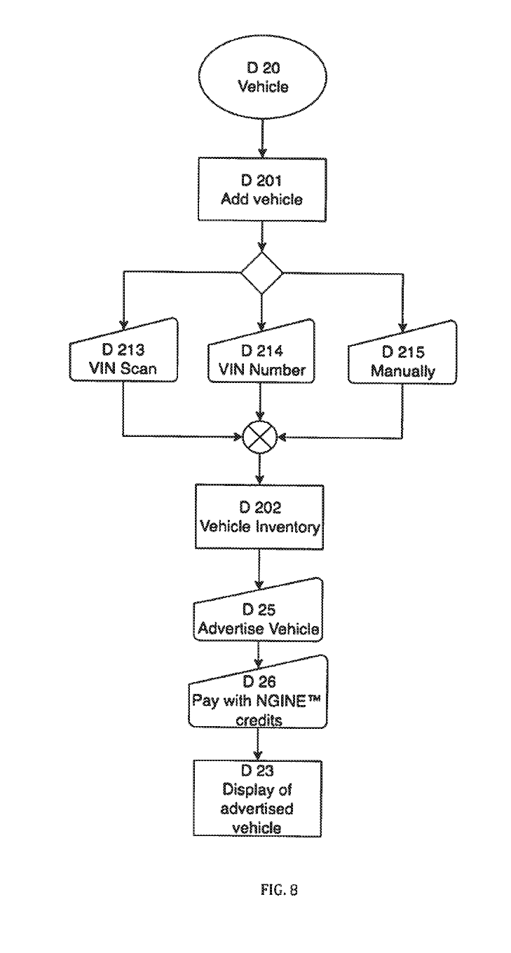

Referring now to FIG. 8 dealer module D20 allows dealers to upload specifications on available vehicles as heretofore discussed. Add vehicle module D201 allows dealers to upload vehicles onto the novel service NS10. Vehicles can be added by VIN scan module D213, VIN number module D214 or manually by module D215. Vehicle inventory module D202 provides a display of all uploaded vehicles including detailed specifications, pictures and videos. Advertise vehicle module D25 allows the user to select certain vehicles to advertise as the best deal and plan on the length of time the vehicle would be advertised and share information with social media platforms. Pay module D26 provides a manual input to confirm payment confirmation for advertising the vehicle which can be paid with NGINE™ credits. Display of advertised vehicle module displays all advertised vehicles for the consumer as well as to the customer as illustrated in FIG. 43.

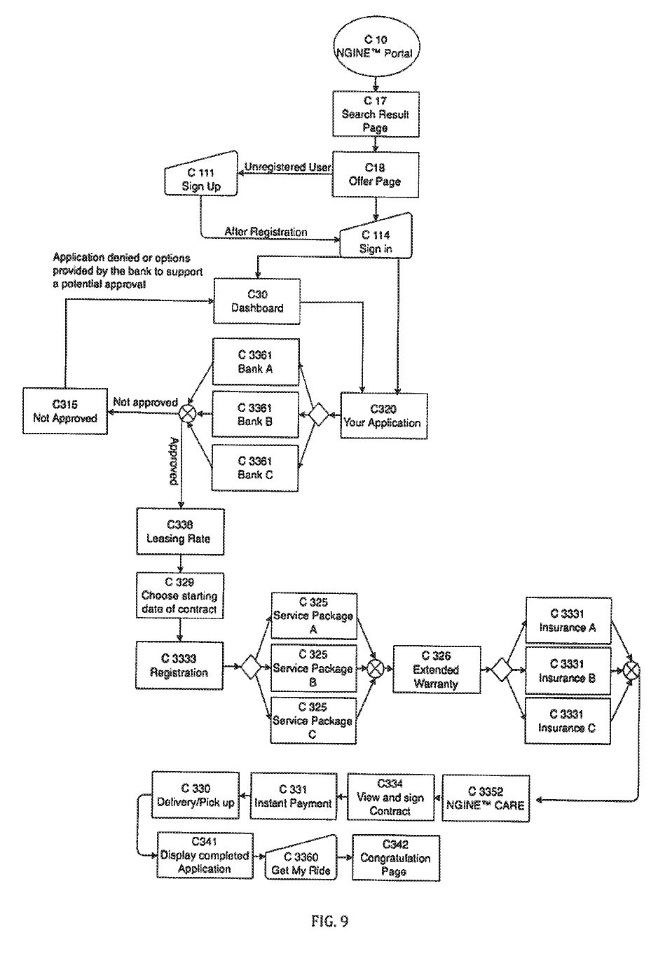

Referring now to FIG. 9 the customer C10 module to the novel NS10 server includes a search result module to display all lease/purchase options, an offer page module C18 which directs unregistered users to a sign up module C111. After registration the user is cleared by a username and password module C114 which opens the customer dashboard module C30 where the user is required to upload information by your application C320 module to complete personal information necessary to purchase a vehicle and obtain insurance for a vehicle as previously discussed. The application is transmitted to a plurality of banks or financial institutions which bid on financing the application in bank module C3361 at which time the application is approved and a leasing or finance purchase installment rate is calculated provided by leasing rate module C338. If the application is not approved, not approved module C315 returns the customer to customer dashboard C30 to possibly purchase other vehicles.

Once a vehicle is leased or purchased registration module C3333 allows the customer to request registration services for the vehicle which seeks bids from service providers to obtain the lowest bid. Service package module C325 allows the customer to select a service package for upcoming maintenance package in which the lowest bid is selected by the purchaser or the lowest and best bid is selected by the fuzzy logic processor of the NS10 server.

Extended warranty module C326 allows the customer to select an extended warranty package and starting date module C329 allows the customer to select a starting date for the lease or purchase contract. Insurance module C3331 allows the customer to change existing insurance as well as change insurance by receiving bids from the lowest bid from an insurance provider or allow the fuzzy logic processor to select the best insurance plan.

Thereafter the customer has the option to become a NGINE™ care customer with care module C3352. View and sign contract module 334 provides a final contract for review and verification by either finger print, facial scan or an e-signature. Instant payment module allows the user to select payment by a variety of different forms of payment as previously discussed. Delivery and pick up module 330 provides for nearly instantaneous pick up or delivery options depending on the vehicle location options and customization. Where the vehicle is located at a great distance due to the nature of the vehicle or its customization a list of logistic companies L10 are provided. Display completed module C341 displays the completed transaction and related documents for the customer's review. Get my ride module C3360 allows the customer to enter into a binding contract once the entire application process has been completed and the entire application is sent to the bank for approval. Congratulations module C342 confirms the application process was successfully completed and stores all information on the My Vehicle module C40 FIG. 6B.

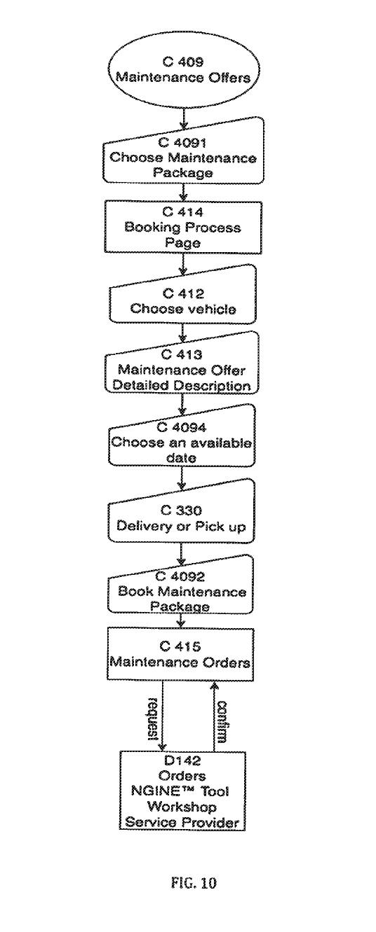

Referring now to FIG. 10 the novel server NS10 includes a maintenance offer module C409 which displays local maintenance facilities. Choose a maintenance module C4091 allows the customer to select a maintenance package. Booking process module C414 allows the customer to select a maintenance package and arrange an appointment, decide a pickup and delivery date and select a method of payment. Choose vehicle module C412 allows a user to select which vehicle is selected for maintenance. Maintenance offer module C413 provides a detailed description of the maintenance including price and scheduled downtime for the vehicle. Choose an available date module C4094 allows selection of a date based on vehicle. Delivery or pick up module C330 provides a pick up date based on the amount of vehicle downtime. Book maintenance module C4092 requires the customer to confirm booking for maintenance. Maintenance order module C415 provides a display of booked maintenance which request is received and confirmed in dealers order module D142 and confirmed on customer's maintenance order module C415.

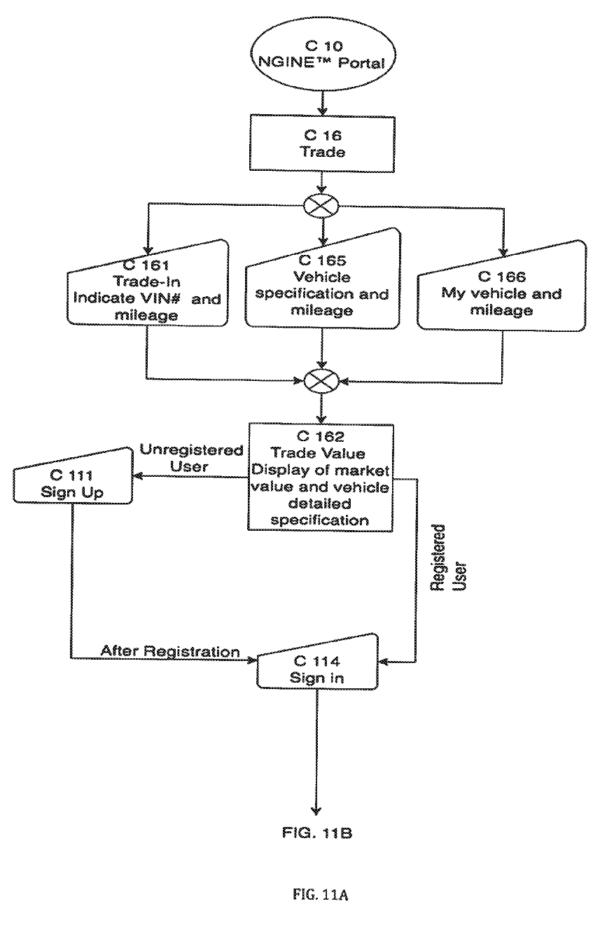

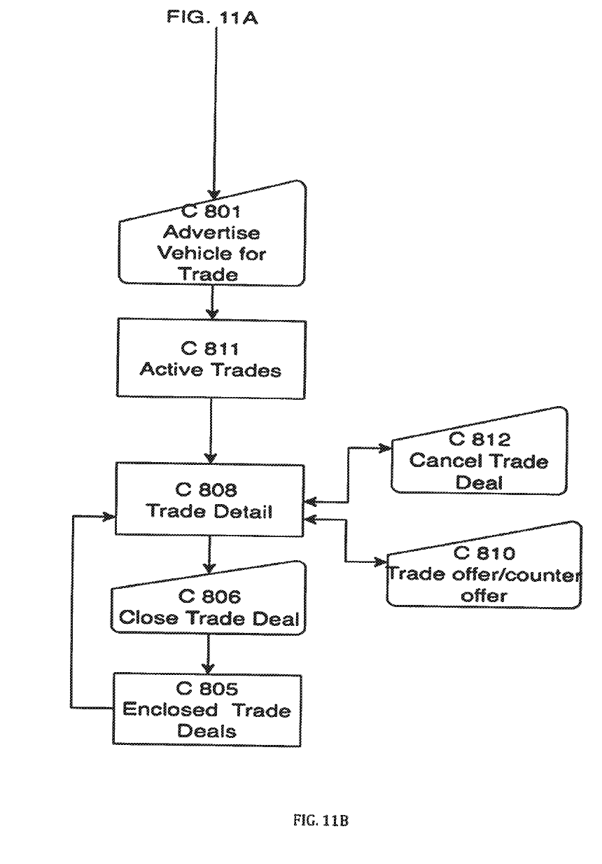

Referring now to FIGS. 11A and 11B the novel server NS10 provides a C10 module to allow the customer to trade a vehicle by enabling the C16 trade module. A trade in module C161 data based on vehicle VIN number and mileage while vehicle specification obtains data based on vehicle type, hours of operation in the case of aircraft and specification of options and changed components while My Vehicle module C166 obtains data manually which results in trade in value module C162 provides an estimated trade in value for the vehicle.

In the event a customer seeking to trade in a vehicle is unregistered sign up module C111 will require the unregistered user to sign up by providing an e-mail address and verification by verification module C112 as previously discussed before sign in module C114 allows a previously unregistered user to sign in or a registered user to use advertise vehicle for trade module C801. Advertise vehicle for trade module C801 includes security questions and requires the uploading of title documents to make certain the customer or user owns the vehicle. Thereafter the customer or user can upload pictures, videos and other vehicle specification data and receive confirmation the vehicle is accepted for advertisement. Active trades module C811 displays all advertised vehicles including detailed specifications of the vehicle and if the vehicle was a previously transferred vehicle under the NGINE™ system all information in the novel server NS10 databases from the manufacturers database E1 and MDW1 dealer's workshop and databases.

Trade detail module C808 displays details about the deal customer information, vehicle specification and dealer or seller's information. If a closed deal is canceled or a deal in progress is not closed the novel server NS10 will activate cancel trade deal module C812 and activate trade offer/counter offer module to allow the parties to negotiate as well as indicate negotiations are in progress and allow any other customers seeking the vehicle to submit their proposed bid. Close trade deal module C806 includes everything needed to close the deal and enclosed trade deal module C805 displays closed deals as well as deals that are in the process of being closed.

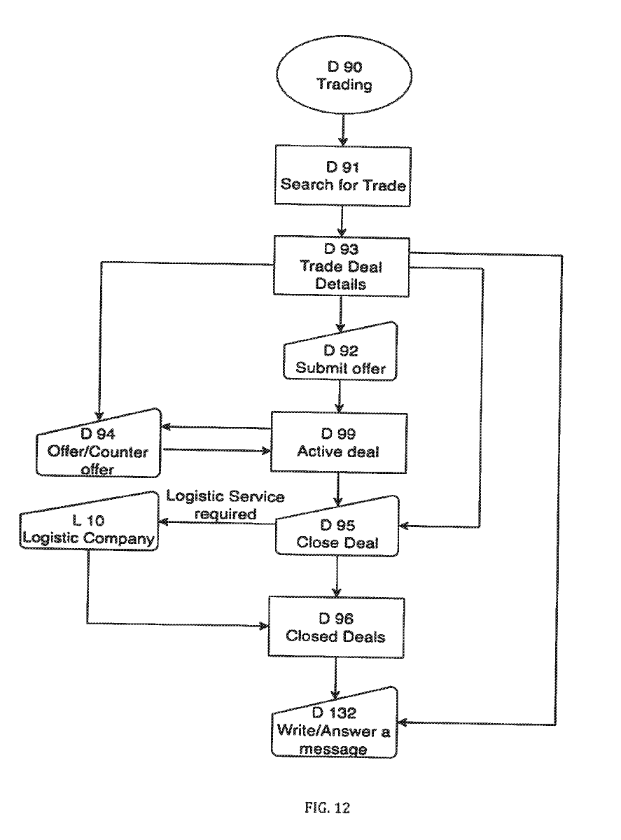

Referring now to FIG. 12 the dealer trading module D90 is illustrated. Dealer trading module D90 provides access to search for a trade module D91 in which dealers can search for trades advertised by a customer on the NS10 server or NGINE™ server. Trade deal details module D93 displays all traded in vehicles by a customer including detailed specifications. Submit offer module D92 requires a manual input to submit an offer for a selected vehicle. Active deals module D99 displays all deals Where an offer has been submitted by a customer or user. The offer is valid for a period of 48 hours and is automatically deleted if the offer has not been accepted. If the offer is not accepted offer/counter offer module D94 provides a manual input to make a further offer or counteroffer which can proceed until the deal is closed by activating the close deal module D95. Close deal module either opens the L10 module to provide for the delivery of the vehicle by displaying information about logistic companies and listed offers or activates closed deals module D96 to display a list of all closed deals. Once the deal is closed write/answer a message D132 provide a manual input to write or answer a message to any NGINE™ system.

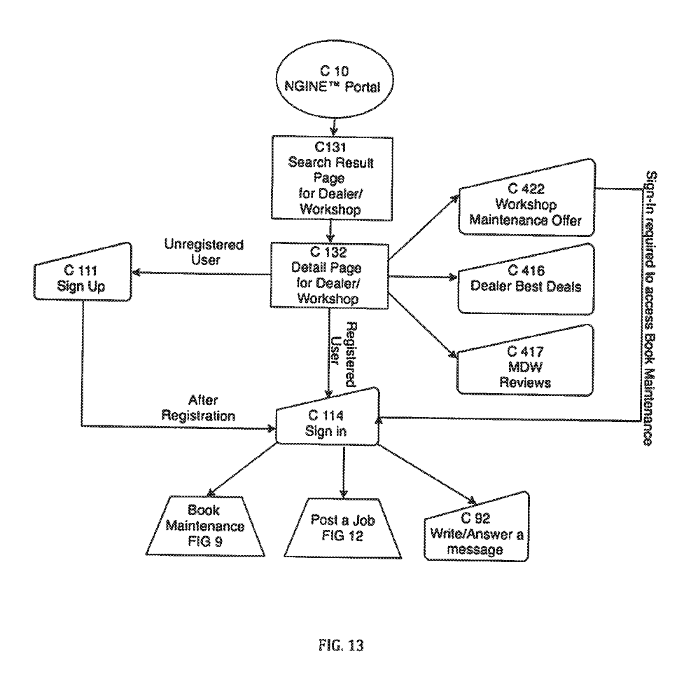

Referring now to FIG. 13 customer portal or module C10 provides the customer access to search result module C131 for a dealer or workshop within a particular ZIP code or radius around a current location. Detail module C132 provides detailed information about the dealer or workshop. Workshop maintenance module C422, access dealer best deals module C416 and obtain reviews from manufacturers dealers workshop module C417. Modules C422, C416 and C417 are functions on the C132 module which can be activated and viewed by the user before sign in/sign up is required. If the user wants to use modules C422, C416 or C417 and if the user is unregistered the user is directed to sign up module C111 to provide information as previously discussed. After verification by sign in module C114 a customer or user can bypass modules C422, C416 and C417 and directly book maintenance under a service package or extended warranty plan in FIG. 9, post a job as previously discussed with respect to FIG. 12 or send or answer a message from write/answer a message module C92.

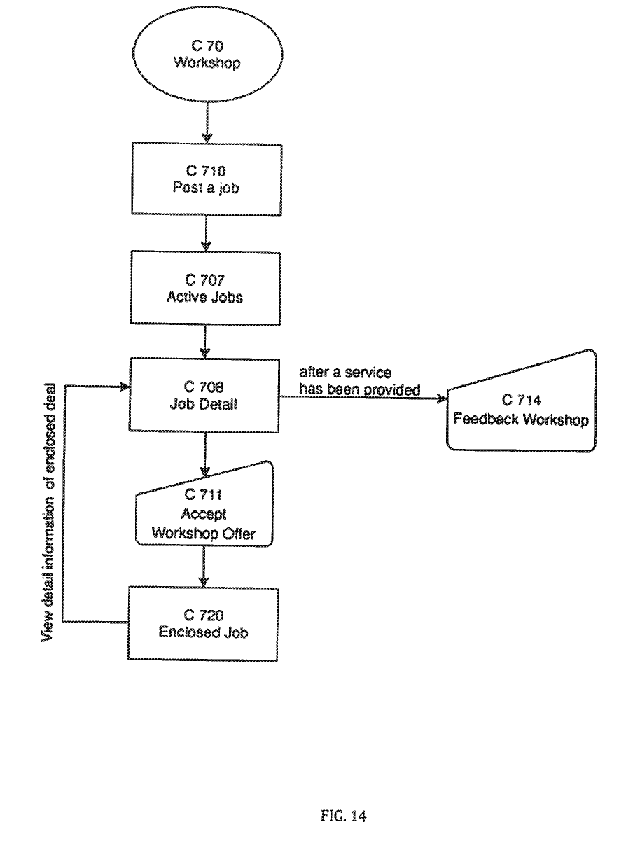

Referring now to FIG. 14 workshop module C70 allows a registered user to post a job from post a job module C710 or post a job for specific services. Active jobs module C707 displays all services that remain open. Jobs detail module C708 provides a display of all jobs and payment option method, accept workshop offer module C711 requires a manual input of the user to accept a workshop offer from a plurality of options and enclosed job module C720 displays all completed jobs. Feedback module C714 provides the user with the ability to comment on completed jobs.

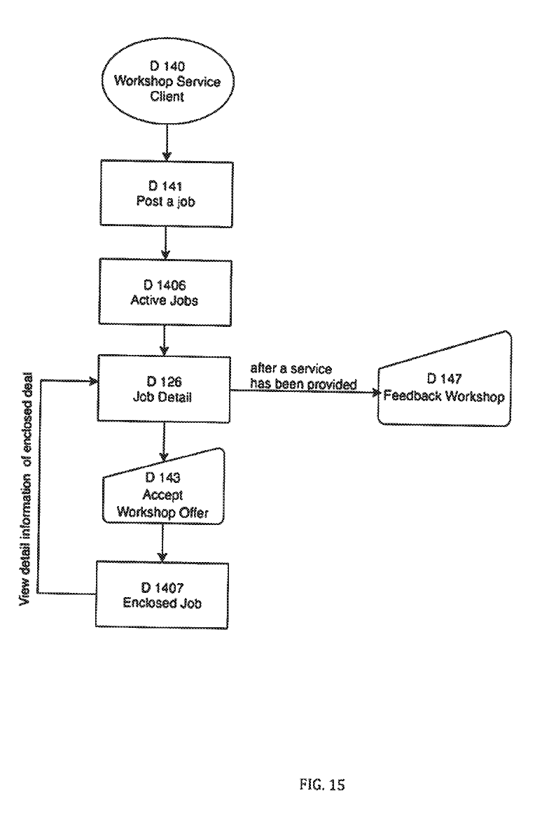

Referring now to FIG. 15 workshop service client module D140 provides a registered dealer access to post a job module D141 and indicate to a customer among other things warranty or service items requiring work. Active jobs module D1406 displays all services acquired from a customer. The dealer can from job detail module D126 display all jobs, job details and payment method options. Accept workshop offer module D143 requires a manual input of the dealer to accept an offer out of provided options and enclosed jobs module D1407 displays a list of completed jobs. Feedback module D147 allows to dealer to access feedback from a customer after completion of a job.

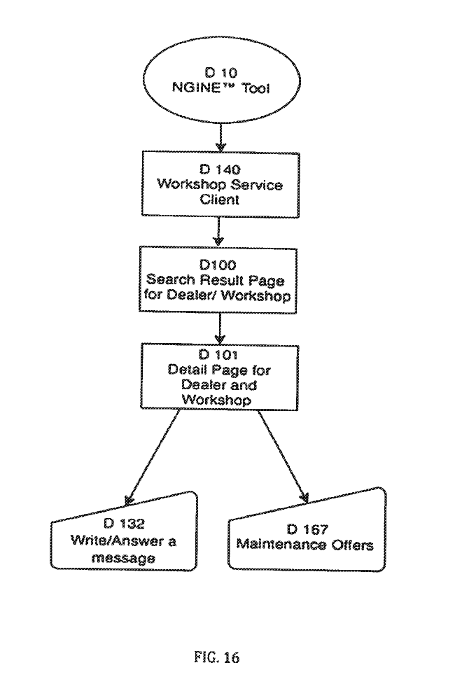

Referring now to FIG. 16 MDW module D10 provides a dealer with the option of booking a maintenance package or list a job for workshop services if the dealer does not have facilities for that service. Search result module D100 displays dealers within a particular ZIP code or within a radius of a location and the services they provide. Detail page module D101 provides detailed information about dealers as previously discussed. Maintenance offers module D167 displays a list of maintenance offers of nearby workshops and write/answer module D132 requires a manual input of the dealer to write or answer a message of any user of the novel server NS10.

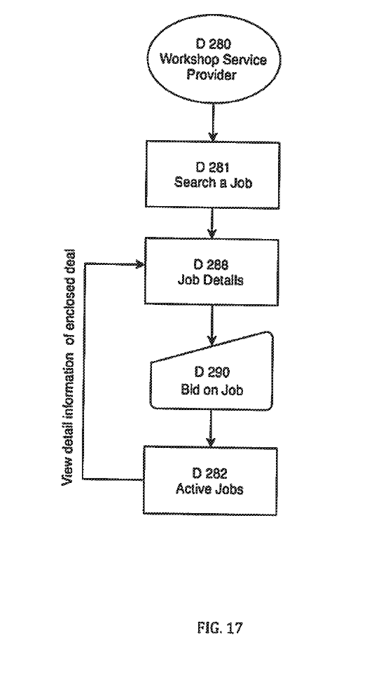

Referring now to FIG. 17 workshop service provider D280 allows dealers to advertise on the novel server or NGINE™ server NS10 workshop services and maintenance packages and provide services to other dealers that do not have a facility for a particular type of maintenance for example, painting. Search a job module D281 allows a dealer to search a job to supplement its facilities. Job details module provides a detailed overview of jobs and maintenance provided, bid on job module D280 requires a manual input to bid on a job out of listed service requests and active jobs module D282 displays a list of all accepted jobs.

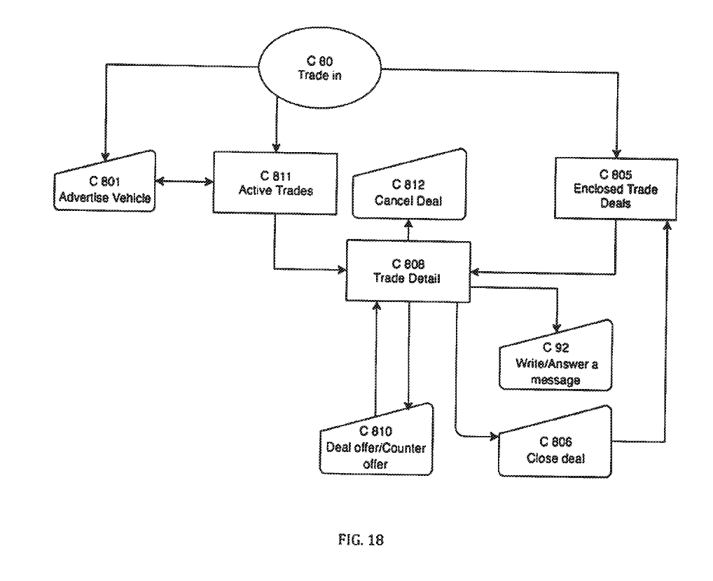

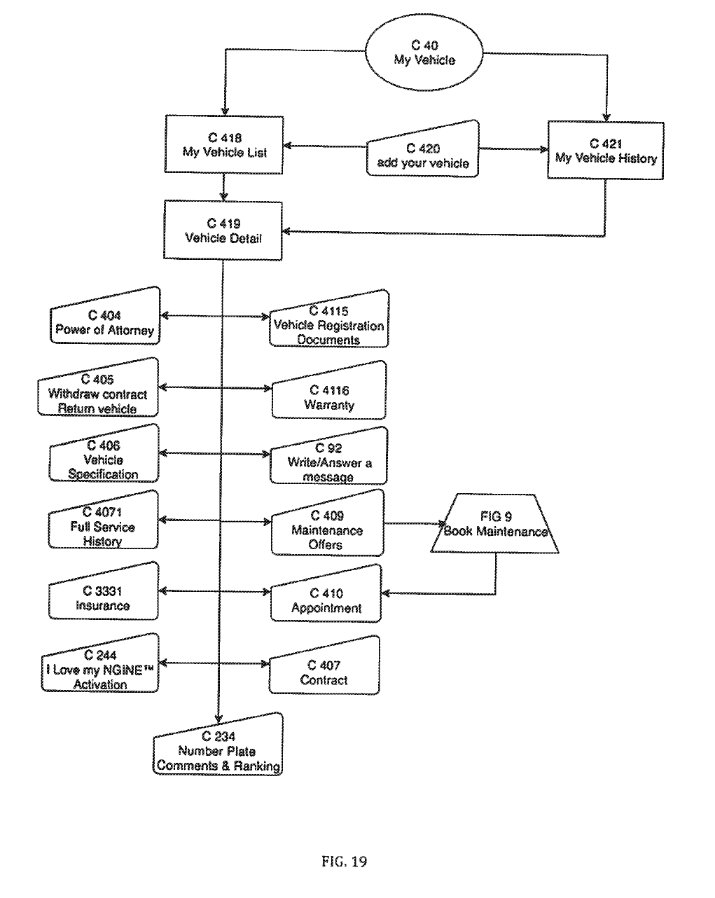

Referring now to FIG. 18 customer trade in module C80 provides access to advertise vehicle module C801 to advertised vehicles or to advertise a vehicle, active trades module C811 which details advertised vehicles and information on all offers received and enclosed trade deals module C805 which displays all closed deals. The user can then access trade detail module C808 which displays details about the deal vehicle specifications and seller or dealer's detailed information. Trade deals module C808 provides access to write/answer a message module C92, close a deal module C806 in which the customer agrees to the deal or of deal/counteroffer module C810 to further negotiate a deal. If a deal is reached closed deal module C806 closes the deal and provides all paperwork required for the deal as will be discussed in FIG. 19 and enters the closed deal into the enclosed trade deal module C805. If a deal is not reached cancel deal module C812 cancels the deal.

Referring now to FIG. 19 My Vehicle module C40 module lists all leased/purchased vehicles for transfer where systems are listed in the history timeline. My Vehicle module C40 oversees vehicle specifications, lease/purchase contract, start a conversation, tool user, request maintenance for leased, purchased vehicles, make appointments, see already chosen insurance and change package, oversee registration documents, manage recently concluded contracts and withdraw contracts, if in the cancellation period, generate power of attorney for delivery/pick up of vehicles, manage current warranty or change warranty package, automated process for generating contracts related to lease/purchase agreements and upload vehicle information that has not been purchased on novel server NS10. My Vehicle module C40 provides access to My Vehicle list module C418 which displays all vehicles purchased or leased on the server NS10. In addition a user can upload external purchased or owned vehicles to their personal account in order to among other things utilize maintenance and in the future trade the vehicle by manually entering the vehicle in add your vehicle module C420 which includes entering vehicle specifications and history in My Vehicle history module C421.

Vehicle detail module C419 provides information on vehicles selected out of My Vehicle module C40. Module C40 provides access to power of attorney module C404, vehicle registration module C4115, withdraw contract module warranty module C4116, vehicle specification module C406, write/answer a message module C92, full service history module C4071, maintenance offers module C409, insurance module C3331, appointment module C410, I love my NGINE™ module C244, contract module C407 and number plate, comments and ranking module C234 all of which were previously discussed. Maintenance offers module C409 and appointments module C410 connect to the book maintenance module previously described in FIG. 9.

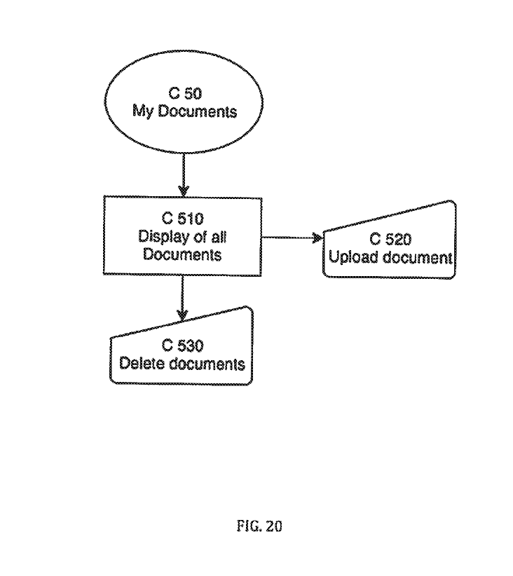

Referring now to FIG. 20 my documents module C50 lists all documents including legal documents of the user that can be uploaded, viewed, edited, printed or deleted. Display all documents module C510 displays all documents uploaded by the user which require among other things identification, processing a lease/purchase application and requesting a service. Upload documents module C520 allows manual input from user of all requirements to upload required documents based on respective country requirements such as driving license, business assessment documents, salary, certificate and other such state, federal and country requirements. Delete documents module C530 requires a manual input of the user to delete documents.

Referring now to FIG. 21 messages module C90 provides a tab access to the message area for overseeing all sent and received messages, start a conversation or respond to a message. All conversations module C91 lists and displays all conversations and messages. Write answer a message module C92 requires a user manual input to write/answer a message to the manufacturer, dealer, workshop and any other user of the server or NGINE™ server NS10.

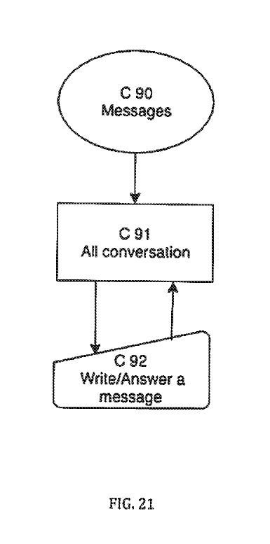

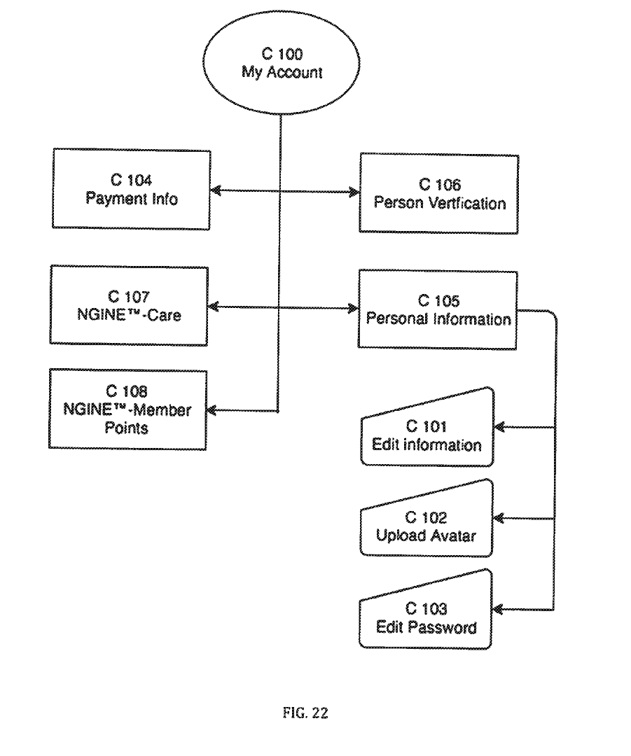

Referring now to FIG. 22 my account module C100 to access payment info module C104 in which the customer is required to provide banking information or any other method of payment information. Personal verification module C106 can provide personal verification by scanning devices such as a camera, an ID card, driving license or any other documents qualified for identification. After that module C106 can optionally scan the user's face which can be verified in an automated process with a prior scanned ID card. NGINE™ care module allows the customer the option to choose to become a NGINE™ care member out of provided packages. Membership can cover any incident involving technical problems with the vehicle or under urgent medical care rescue. NGINE™ member module C103 provides member points with no limitation by making reviews and providing comments to a brand, model, dealer, manufacturer, workshop or other use of the NGINE™ system as well as searching for a specific product, starting an application, providing or utilizing a service, etc. Activities are categorized in a scoring system and will be distributed and displayed for the customer's convenience. Based on the amount of collected points the NGINE™ system offers promotional incentives and rewards that can be applied to the purchase of goods or services.

NGINE™ care module C107 includes access to personal information module C105 which includes a display of detailed personal information, edit information module C101 which requires a manual input by the customer to edit information as well as upload avatar module C102 which allows the user to select a personal profile picture to be displayed when logging into their personal account. This allows the user when signing in to allow an uploaded picture to be replaced with a sign in sign up button. Edit password module C103 allows a customer to edit a password for access to their personal account.

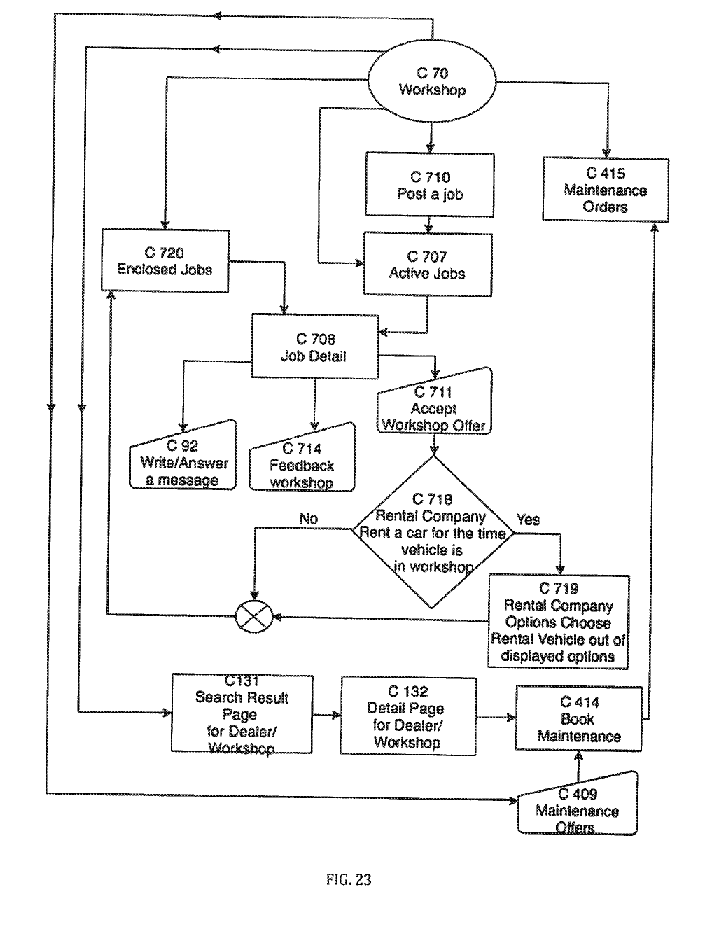

Referring now to FIG. 23 customer workshop module C70 allows a user to search for a specific workshop or service and/or advertise a desired working request. Workshop module C70 allows a user to access post a job module C710 to display a form for a posted job and indicate among other things specifications for the required service. Post a job module C710 or workshop module C70 provide links to active jobs module C707 which provides a display of all services acquired from the customer. Active job module C707 provides links to job detail module C708 which displays all jobs and their details and payment method options. Job detail module C708 can also be accessed through enclosed jobs module C720 from workshop C70 module. Enclosed jobs module C720 displays all accomplished jobs.

Job detail module C708 provides access to accept workshops module C711 which requires a manual input of the user to select an offer out of a plurality of options, Accept workshop offer module C711 links to rental company module C718 to make certain the customer has transportation while the vehicle in maintenance or a loaner car is provided. If a rental car is needed rental company module C719 displays a list of rental companies including details for offers.

Workshop module C70 provides direct links to search results module C131 which provides a display result page for dealer workshop which can be searched by ZIP code or an indication of a radius around a current location. A detail page module C132 provides detailed information about dealers, workshops, contact information, operating hours, sales contact, list of reviews, best deals, maintenance offers, option to follow dealer or workshop in order to receive offers and news from a particular workshop. A user can book maintenance in book maintenance module C414 which module displays of available or chosen maintenance packages, maintenance package the user chose for the vehicle, the maintenance package vehicle is booked for, the option to choose a date from the workshop appointment, pickup and delivery service, choose method of payment and confirm booking of selected options. Workshop C70 also provides a link to the book maintenance module C414 through a maintenance offers module C409 which displays for the user a list of maintenance offers of all workshops nearby the customer's location. After completion of maintenance a user can access maintenance order module C415 to display all booked maintenance service orders and write/answer module C92 to write/answer a message as to the service provided as heretofore discussed.

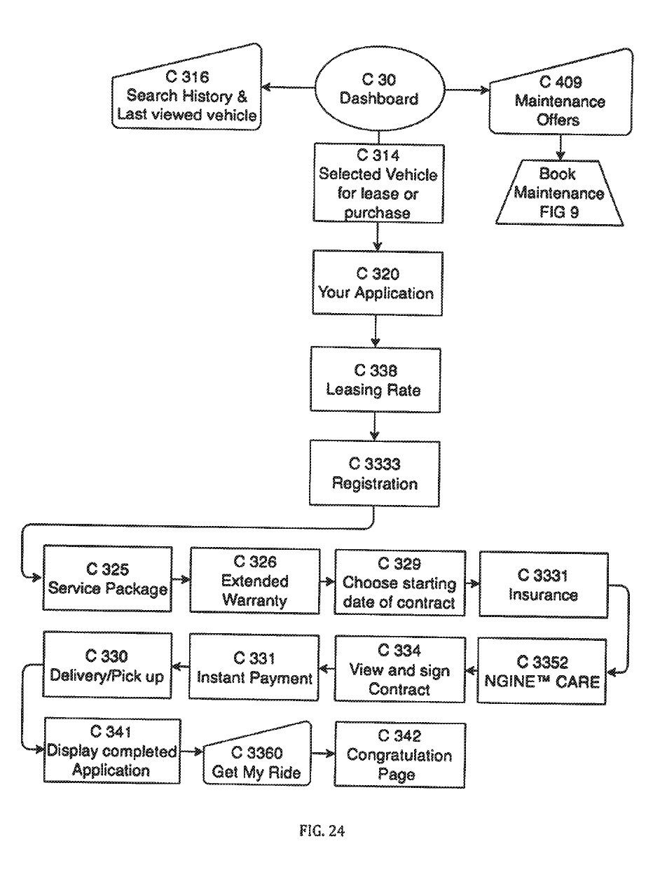

Referring now to FIG. 24 an alternative embodiment to FIGS. 9 and 49 the customer dashboard module C30 provides a link to the maintenance offers module C409 and the book maintenance offers modules as discussed with respect to FIG. 9. Customer dashboard module C30 also provides a link to search history and last viewed vehicle module C316 which displays the search history and last vehicle displayed. This module assists the user in refreshing search results of previously viewed searches. Customer dashboard module C30 provides access to select vehicle module C314 which displays selected vehicles for lease or purchase and accesses your application module C320 to review selected vehicle specifications or provide updated information on the status of an application which provides for example access to leasing rate module C338 which displays leasing rate provided by a bank based on the creditability and credit score of the user.

Once a leasing rate is provided registration module C3333 provides the user with the option to request a registration service for the leased or purchased vehicle. If this option is selected a service package will be displayed and added to the vehicle price. In an alternative embodiment of the invention various service providers can provide bids from which the user can select the lowest bid price displayed or allow the Fuzzy Logic Processor obtain the best bid at the lowest price. Service package module 325 similarly provides the option for the user to select a service package such as an extended warranty from extended warranty module C326 as well as selecting a starting date using choose a starting date module C329. Insurance module C3331, NGINE™ care module C3352, view and sign contract module C334, instant payment module C331, delivery/pickup module C330, display completed application module get my ride module C3360 and congratulations page module C342 all provide selections and options to complete the transfer of the vehicle as previously discussed.

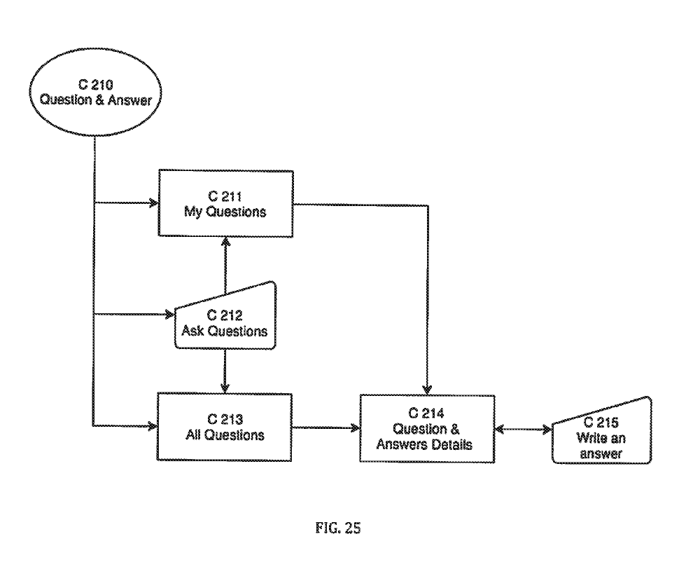

Referring now to FIG. 25 a question and answer module C210 allows users to exchange information among each other about brands, models, manufacturers, dealers and workshops as to their products and services and about the NGINE™ system. My questions module C211 displays questions set by the user. Asked questions module C211 displays all listed questions particular to the user and all questions module C213 displays a list of all received questions and questions set by the user. Questions & answer details module C214 provides a detailed view of received questions and answers. Write an answer module C215 requires a manual input by the user to write an answer to a question.

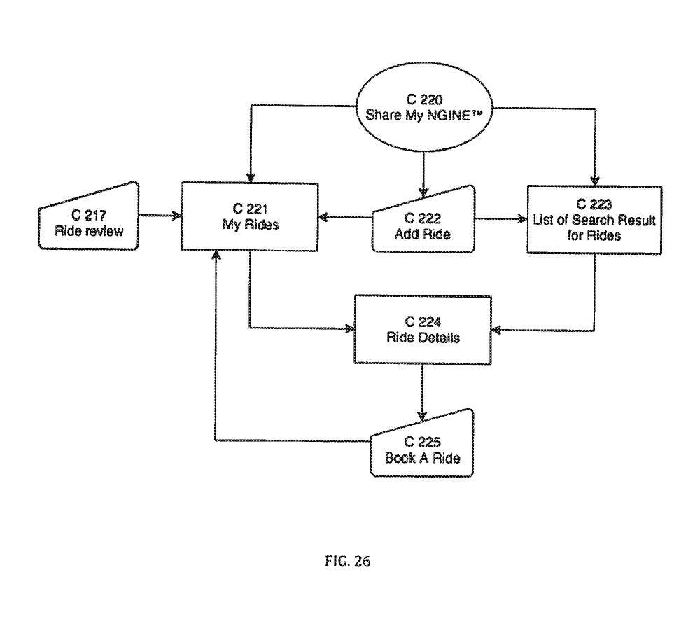

Referring now to FIG. 26 share my NGINE™ module C220 provides a vehicle shared use, fractionalized ownership or partnership arrangements among users of the novel server NS10. This module can also offer seats available on planes, sailboats or other vehicles that can be advertised for potential customer convenience. This feature is primarily available for long term lease purchase operations or for long journeys. Module C220 includes my rides module C221 for displaying a list of all personal offered and booked rides as well as offers for partial or shared ownership options. Add ride module C222 requires a manual input to add another fractionized or partial owner or an offer for a ride possibility. List of search results module C223 displays a list of potential fractionalized owners or partners or users seeking a potential ride. Ride details module C224 provides a display for a specific potential trip or use of a vehicle such as a sailboat for a particular number of days. Book a ride module C225 requires a manual input to book a ride and ride review module C217 allows a customer or rider to write a review about a booked ride.

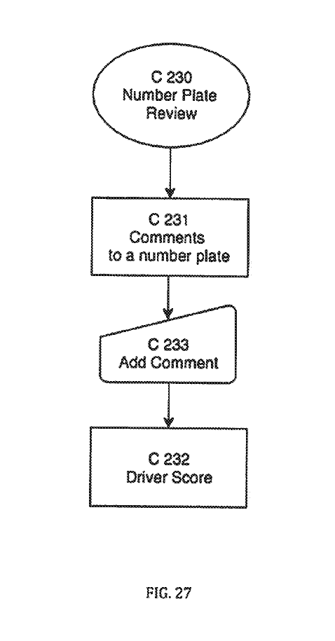

Referring now to FIG. 27 a number plate review module C230 provides for review and write feedback on vehicle number plates. Feedback to a number plate will be shown only to the owner of the commented number plate. Other users of the NGINE™ system see only the ranking of the vehicle number plate and not the actual comments. Comments to a number plate module C231 display a form for writing comments about a vehicle number plate. Add a comment module C233 provides confirmation to send comments from module C231. Driver score module C232 displays a scored ranking for vehicle number plates of members.

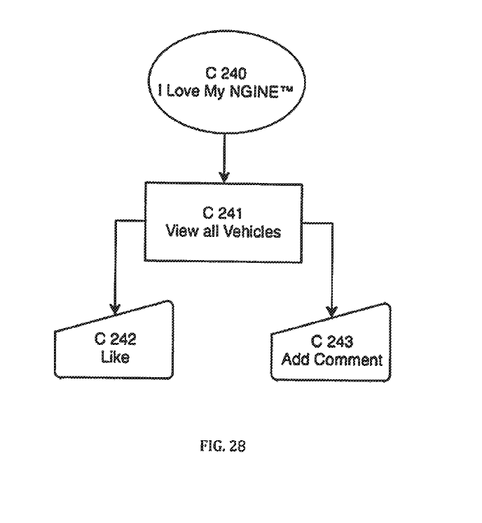

Referring now to FIG. 28 I love my NGINE™ module C240 allows users to share their experience with a leased or purchased vehicle and allow them to make their comments or experiences available to other users of the NGINE™ system. View all vehicles module C241 displays comments of other customers about their vehicle. Like module C242 requires a manual input of a customer indicating a positive feedback about a comment by pressing a button. Add comment module C243 also requires a manual input by the user to add a comment to a displayed review of a vehicle.

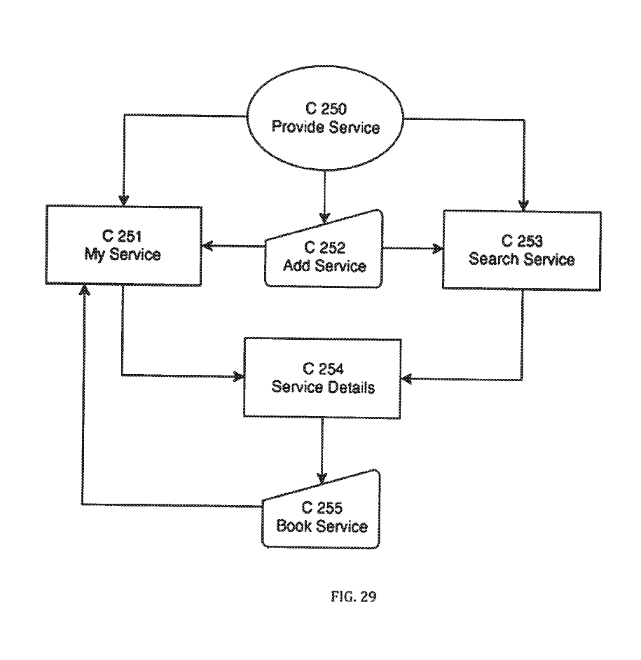

Referring now to FIG. 29 provide service module C250 provides the user with the option of providing or searching for a service without limitation to lease opportunities to parking space airport hangar, ship docking, location of fuel facilities including gas stations, electro charging stations, hydrogen stations or other vehicle services for parking or vehicle operation. Module C250 provides access to module C251 to display an overview of advertised services or provide a search for a service including lease for parking space, hangar space, ship docking and fuel locations including gas stations, electro charging stations, hydrogen stations or other vehicle services. Add service module C252 requires manual input by the owner to add a service offer. Provide service module 250 also includes a user option to search for a service pertaining to a vehicle using search service module C253. Service details module C254 provides a detailed description of the services available or searched by the user and book service module C255 requires a manual input by the user to book services using book services module C255.

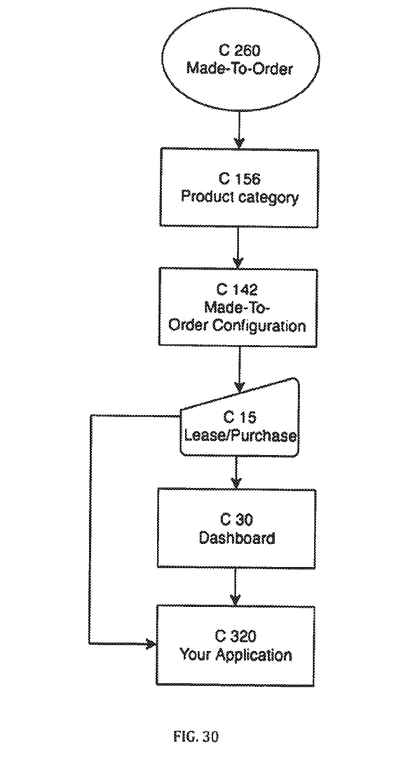

Referring now to FIG. 30 made to order module C260 allows the user to place a specially configured vehicle order such as bullet proof glass customization of an existing model or modification of a model which provides access to product category module C156. Product category module 156 allows the user to select a particular vehicle and select options or components for a specific vehicle such as a combustion vehicle, electric car, hydrogen vehicle, cars, drones, motorcycles, trucks, construction vehicles, ships, planes, cars helicopters, etc. Made to order configuration module C142 allows the customer to customize a vehicle based on personal wishes and requirements. Lease/purchase model C15 requires the customer to select whether a lease or purchase is selected for the chosen vehicle, Dashboard C30 module then displays the customized vehicle or its specifications for lease or purchase which then opens your application module C320 for the purchase of the customized vehicle with the specifications for the customized vehicle, financing options, insurance, registrations, payment, delivery and logistics L19 selections arranged through the novel server NS10.

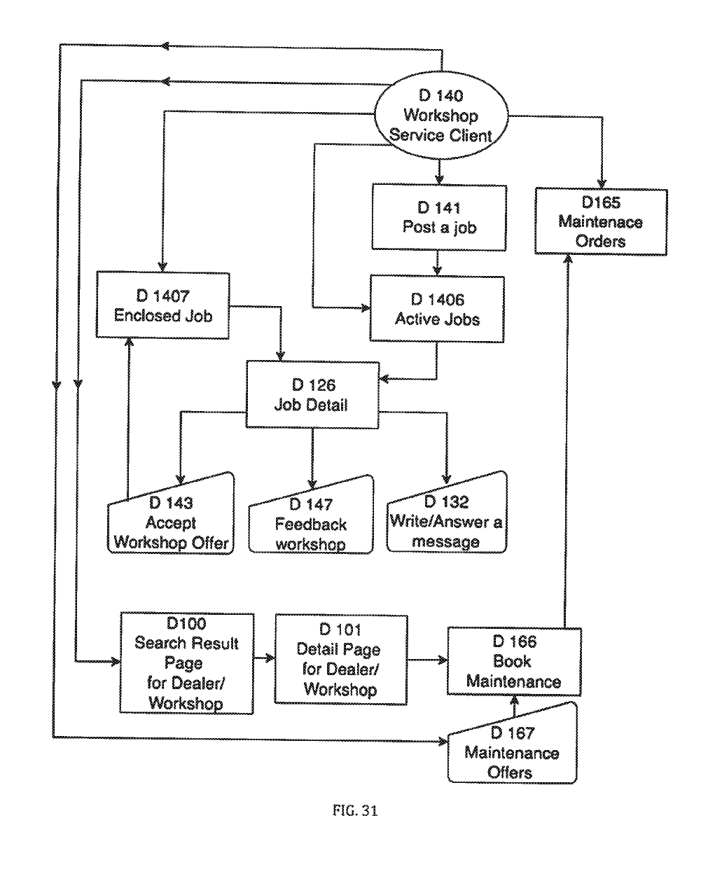

Referring now to FIG. 31 dealer workshop module D140 provides access to dealer or workshop services option such as posting a job in post a job module D141. Post a job module D141 provides a display for posting a job in which the user provides a specification of required service. Active jobs module D1406 displays all of the services previously acquired from a customer. Active jobs module 1406 opens job detail module D126 which displays all jobs and details and payment method options. The workshop can accept the workshop order by manually accepting the workshop offer in accept workshop offer module D143 which then displays the job added in the enclosed job module D1407 and books the maintenance package or job for workshop services in maintenance order module D165 which includes a display of all maintenance orders which is then manually booked into book maintenance module D166.

Dealer workshop module D140 can directly book maintenance to book maintenance module D166 through maintenance order module D165. Alternatively maintenance can be booked through maintenance offers module D167 as a result of a selection of maintenance offers module D167 or the result of a search result module D100 where a dealer was searched by a customer or another dealer and the dealer was selected from detail page module D101 from a group of displayed dealers. After completion of the maintenance feedback workshop module D147 allows the user to provide feedback about the workshop. Write/answer module D132 requires a manual input to write or answer a message to any user of the system regarding maintenance or any other issue.

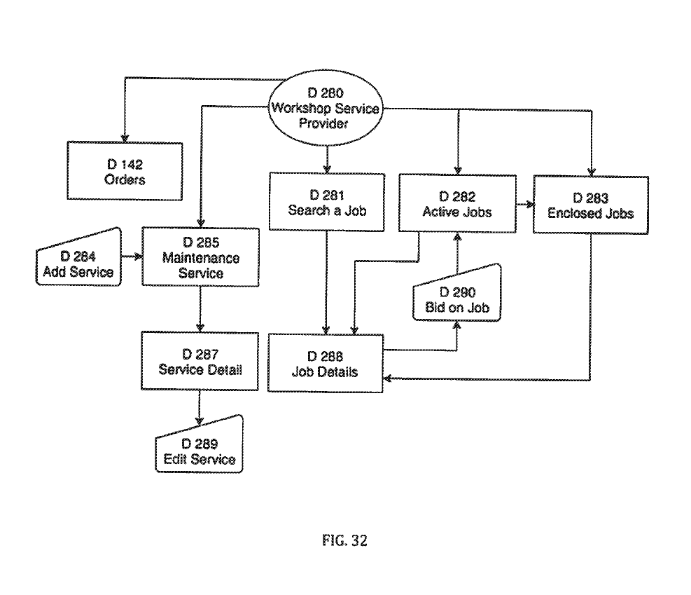

Referring now to FIG. 32 workshop provider module D280 is only accessible for a workshop owner where general workshop services are provided and maintenance packages can be advertised on the NGINE™ system. Workshop provider module D280 services are also available to dealers that do not have their own workshops or have limited available workshop services. Orders module D142 provides a display of booked maintenance orders by dealers or customers. Workshop service provider module D280 provides a display of all accepted jobs on active jobs module D282 and a display of complete enclosed jobs for enclosed module D288. Workshop service provider module D280 also allows a user to search a job out of listed requests advertised by a customer or user of the NGINE™ server that does not have a shop or particular types of shop facilities. Maintenance service module D285 displays a list of all advertised maintenance packages. Add service module D284 allows additional service packages to be advertised. Service detail module D287 provides a display of a detailed overview of a particular maintenance service. Edit service module D289 requires a manual input to edit an advertised maintenance package offer.

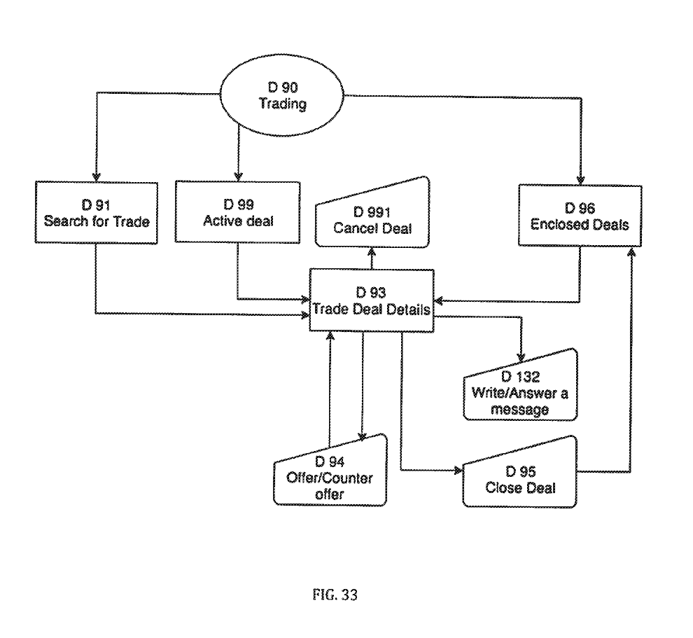

Referring now to FIG. 33 trading module D90 provides a trading area where a user can trade vehicles advertised by a customer. Trading module D90 provides access to search for a trade module D91 which displays trade possibilities for vehicles advertised by a customer on the novel server NS10. Trading module D90 provides access to active deal module D99 which displays all deals where an offer has been submitted by a user. The offer is valid for a period of 48 hours and will be deleted automatically if the customer has not shown further interest in the deal. Search for trade module 91 and active deal module are connected to trade deals module D93 which displays all traded in vehicles by a customer including detailed specifications on the vehicle. Trade deals module D93 allows access to close deal module D95 where the user accepts the deal by activating a tab to the module or engages in offer/counteroffer negations in offer counter offer module D94 or cancels the deal in cancel deal module D991 which requires a manual input by either party. Alternatively, if the deal is accepted, close deal module D95 provides access to enclosed deals module D96 to remove the vehicle from search for trade module D91.

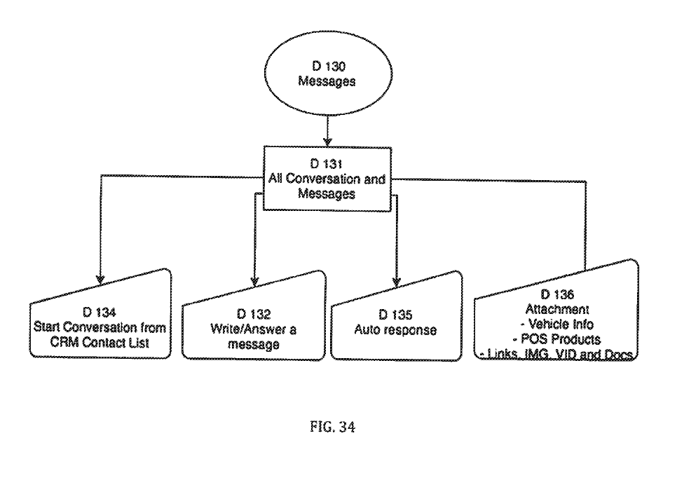

Referring now to FIG. 34 messages module D130 provides access for overseeing all received and sent messages including starting conversations or responding to a message. All conversations and messages module D131 displays a list of all conversations and messages with a customer. Start conversation module D134 allows a dealer to choose a contact listed in the CRM to start a conversation or write a message. Write/answer module 132 requires a manual input from the user to write or answer a message from any user in the novel NS10 server. Auto response module D135 is a user default message system where a responsive message is sent immediately when a customer starts a conversation with an employee of the manufacturer dealer workshop (MDW). Attachment vehicle info module D136 allows the user to attach documents such as vehicle detailed information, POS, products, images, videos, documents, etc. in a message.

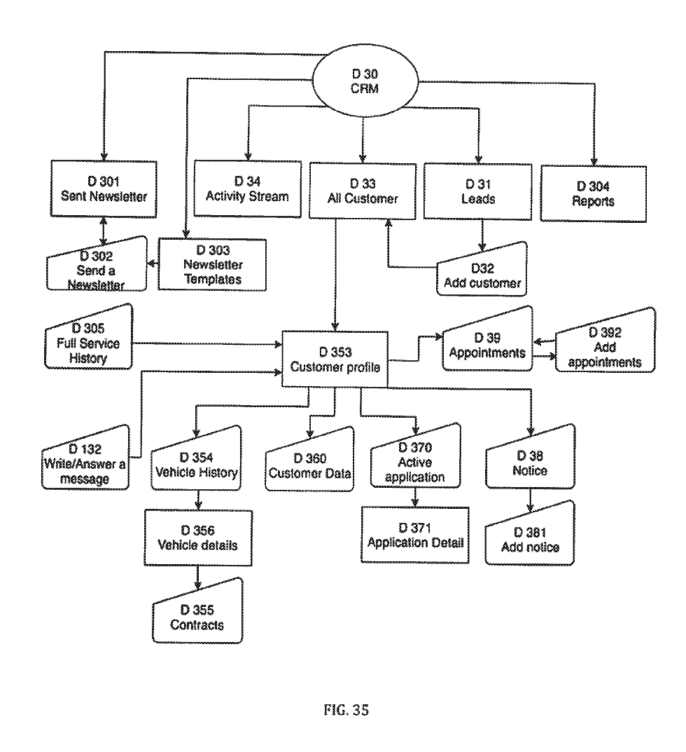

Referring now to FIG. 35 CRM module D30 opens the CRM area to provide user management of all existing customers, oversee all offers for lease/purchase contracts, customer detailed information, add and edit customers, track activity indication for each customer individually, control customer export/import information such as sharing for back up purposes, oversee vehicle information, contract terms, make appointments and manage a list of leads with the possibility of adding leads or to contact a lead. CRM module D30 optionally includes a send newsletter module D301 to display a list of all newsletters sent to customers. A send a newsletter module D302 requires a manual input to create a newsletter based on a newspaper template and have it sent to all customers registered in CRM. CRM module D30 also includes a newspaper template module D303 to display newspaper templates from which the user can select and adjust news releases based on personal requirements. CRM D30 module optionally includes an activity stream module D34 which displays all activities between employees and customers.

CRM D30 module preferably includes an all customer module D33 which displays a list of current customers, a leads D31 module to display all incoming leads from MDW websites, landing pages and users of the MDW NGINE™ website and a reports D304 module which provides a display of a list of reports with detailed content about all activities between employees and customers. The leads module D31 includes an add customer module D32 to add new customers to the all customers module D33. The all customers module D33 includes a customer profile module D353 where the user can manage and view the customer's detailed specification, set appointments, send messages, view vehicle history, view active applications and notices. CRM customer profile module D353 includes an appoints module D39 to display all set appointments and a D392 module to manually add appointments.

Customer profile module D353 includes links to a vehicle history module D354 to display vehicle specifications and a vehicle details module D356 to display a list of detailed technical specifications for a chosen vehicle and a link to contracts module D355 to display all approved lease/purchase contracts. Customer profile module D353 optionally includes a customer data module D360 which displays customer's detailed information. Customer profile module includes links to an active application module D370 which displays a list of pending lease/purchase application in process in your application C320 module. Contracts that have been approved will be displayed in contracts D355 module and the vehicle specification will be added to the vehicle history D354 module. The active application module D370 also includes a link to the application detail module D371 which displays detailed information of a particular chosen application to indicate status of the approval process, detailed specification of the vehicle and detailed information on the applicant. Customer profile module D353 also includes access to notice module D38 which displays all added notices by employees regarding the customer, the specifications for vehicles of interest and other notes. An add notice module D381 allows the manual input of further notices and information.

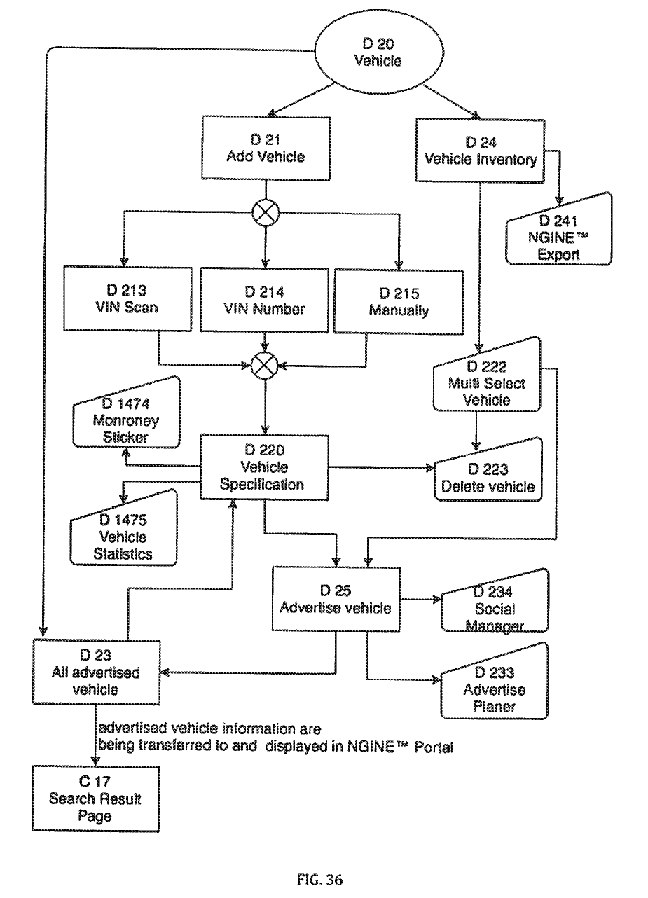

Referring now to FIG. 36 vehicle D20 module provides for the manufacturer and/or dealer to upload technical specifications to the novel server NS 10 to be advertised or displayed for leasing, purchasing or other transfer of vehicle arrangement. Preferably the vehicle is uploaded using a VIN number as a means of extracting specifications on the vehicle. A list of the entire uploaded vehicle inventory is provided from which the user can choose which vehicles are advertised for lease and purchase including special deals. Analytical information includes but is not limited to an overview of inventory fluctuation, status of inventory including but not limited to information on already advertised vehicles indicating popularity of a model with no limit to how many times a customer has parked or clicked on to a short list for later review or a vehicle has been viewed or supported by displaying charts and percentage indication. Information on total sales volume and sales profit of transactions can be calculated by the server NS10.

Server of NGINE™ server NS10 includes an add vehicle module D21 to provide a manual input required to start uploading a vehicle as inventory on the server NS10. Vehicles can be uploaded to the server NS10 by a VIN scan using the VIN bar code on the vehicle which preferably includes all vehicle data including components and subcomponents and includes all vehicle specifications including picture, manufacturer suggested retail price (MSRP) and residual value so that the system can adopt vehicle technical specifications and lease purchase or other transfer terms and price. Not all components and subcomponents need to be made available and may be filtered due to sheer volume since a purchaser may not be interested or care about the manufacturer of items not critical to safety such as seat cushions. However even non safety components should be available for later review in view of the fact that consumer complaints or service difficulty reports can be processed in the novel server NS10 and result in the change of that component in a future vehicle as previously discussed. Add vehicle module D21 also includes a VIN number D214 module to allow a VIN number of a vehicle to be manually entered in the field so the system can upload the vehicle specification directly onto the server NS 10 with all vehicle specifications including picture MSRP and residual value so that the server NS10 can adopt the vehicle technical specifications and lease purchase or transfer terms and price. Add vehicle module D21 also includes a manually D215 module that allows the user to fill in all fields manually by indicating/uploading the vehicle technical specifications including picture, MSRP and residual value for determining lease, purchase or other transfer terms and price.

Referring again to FIG. 36 a vehicle specification module D220 which provides a detailed display of vehicle specifications for a selected vehicle. Vehicle specification module D220 includes links to vehicle statistics module D1475 which displays charts containing information about a particular vehicle selected including how many times the vehicle has been parked, unparked or viewed on the server NS10. Vehicle specification module D220 includes links to the advertise vehicle module D25 which includes use, advertise planner best deal and links to other media to indicate where and how long the vehicle has been advertised and information on social media platforms which is particularly useful in the introduction of new models. Vehicle specification module D220 also links to advertise vehicle module D25 which allows the user to choose from selected inventory the best time to advertise a vehicle on the server NS10 and share information about the vehicle on social media platforms. Advertise vehicle module D25 in turn includes links to social manager module D234 which allows the user to share information about the vehicle on social media platforms. Advertise vehicle module includes a link to advertise planner D233 a manual input module which asserts in planning the start date and total period of time the vehicle would be advertised on the server NS10. Advertise planner D233 can also include a sequence planner so if the user is advertising 10 vehicles at the same time each vehicle has a time difference for the length of time it is advertised and with the time difference correlated to its appearance on social media.

Advertise vehicle module D25 includes a link to all advertised vehicles module D23 which displays the vehicle and provides information that will be displayed in consumer search result page module C17. Advertise vehicle module D25 to the delete vehicle module D223 through either the vehicle specification module D220 or through the multi select vehicle module D222. The multi select vehicle module D222 provides the user with the option of selecting how to manage the advertisement of a number of vehicles at one time.

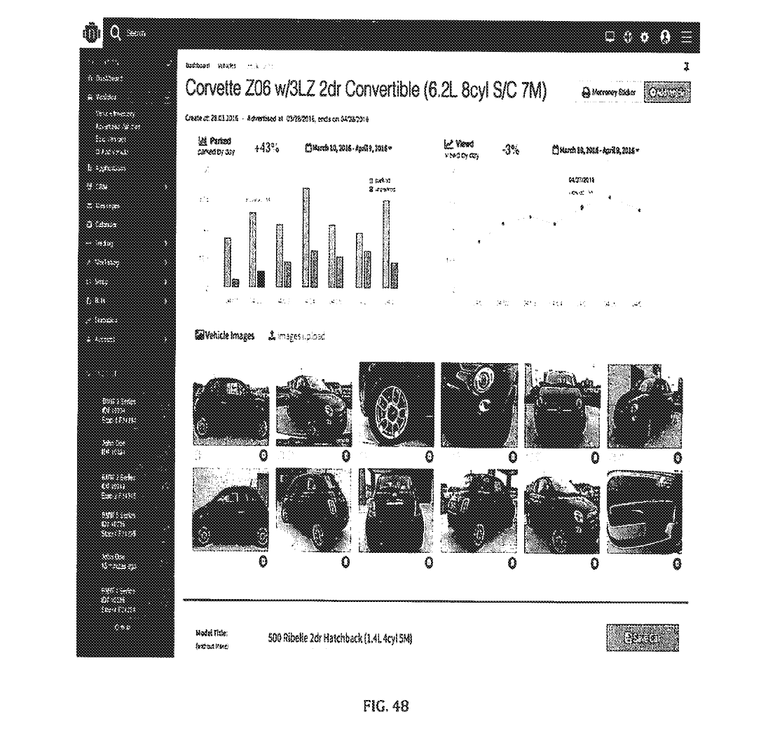

Referring again to FIG. 36 vehicle module D20 includes a vehicle inventory module D24 which displays all vehicle inventory uploaded on server NS10 an example of which is illustrated in FIG. 48. Vehicle inventory module D24 includes a link to the multi select vehicle module D222 which has already been discussed as well as a link to the server NS10 export module D241. The export module allows the user to select a vehicle out of inventory and export technical information and pictures to exchange information with third parties, a cloud storage provider or download for self use. Vehicle detailed information including pictures are generated by the novel server NS10 with a JSON file. JSON (Java Script Objection Notation) is a lightweight data interchange format and therefore requires less data to communicate vehicle specifications between the server or NGINE™ server and third parties.

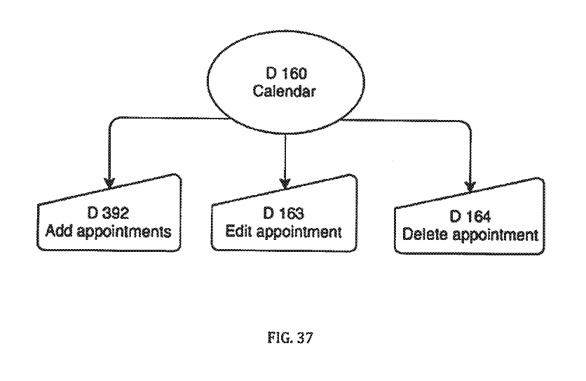

Referring now to FIG. 37 calendar module D160 allows the use to make and oversee appointments, arrange pickup and delivery of vehicles, schedule maintenance requests and schedule test drives. Calendar module includes a add appointment module D392 to add appointments with a manual input. Calendar module D160 also links to an edit appointment module D163 and a delete appointment module D164 in which appointments are added or deleted manually respectively.

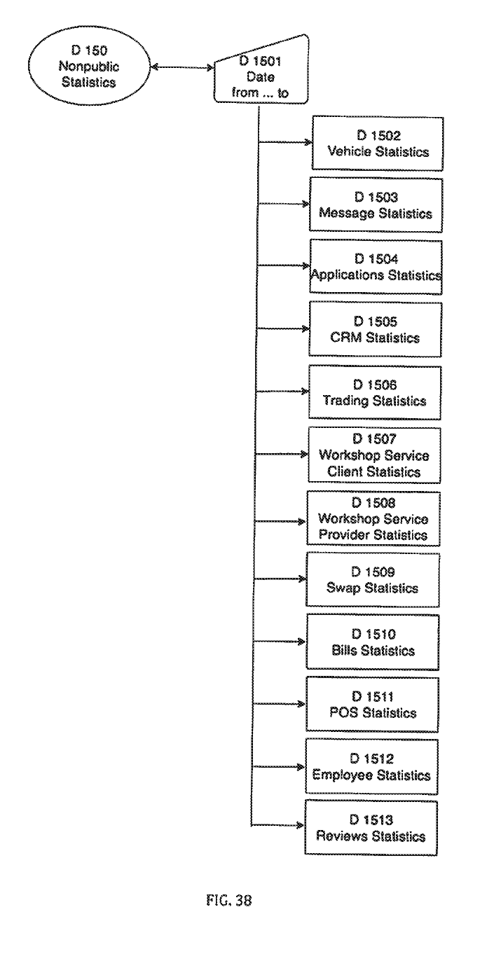

Referring now to FIG. 38 a nonpublic statistics module D150 provides a link to nonpublic statistics which include such things as overview of vehicle inventory fluctuations, message interactions, lease/purchase applications, client activities, trading, workshop services, swap of vehicles, bills, point of sale (POS), employee and reviews for provided products and services. The overview is only accessible to the administration of the NGINE™ or server tool. The statistic module provides a link to a date from/to module D1501 which provides a date from/to and requires a manual input for a period of time for the display of statistic overviews. A default overview without user input is set for a period of 30 days.

The date from/to module allows the from/to date to organize such things as vehicle statistics module D1502, message statistics module D1503, applications statistics module D1504, CRM statistics module D1505, trading statistics module 1506, workshop services client statistics module D1507, workshop services module D1508, swap statistics module D1509, bill statistics module D1510, POS statistics module D1511, employee statistics module D1512 and review statistics module D1513. Vehicle statistics module D1502 includes data on inventory, profit and loss advertising costs, budgets and efficiency of the various systems. Message statistics module D1503 includes a statistical overview of the total amount of messages and conversations and the daily average and sales. Applications statistics module D1504 includes statistical data on all interactions in the CRM. Trading module D1506 provides a statistical overview about vehicles traded, amount of investment for trading as a total amount and daily average. Workshop service module D1507 provides statistical data displaying the value of respective maintenance packages and workshop services as a total amount and daily average amount. Swap statistics module D1509 provides a statistical overview about swap activities as a total amount and a daily amount. Bill statistics module D1510 provides statistical information on all bills, open bills, paid bills as a total amount and daily average amount. POS statistics module 1511 provides a statistical overview about products, sales and sales employees as a total amount and daily average amount. Employee statistics module D1512 provides a statistical overview about the amount and cost for employees as a total amount and daily average amount. Review statistics module D1513 provides a statistical overview about the amount of reviews as a total amount and daily average amount. POS statistics module 1511 provides a statistical overview about products, sales and sales employees as a total amount and daily average amount. Employee statistics module D1512 provides a statistical overview about the and cost for employees as a total amount and daily average amount. Review statistics module D1513 provides a statistical overview about the amount of reviews as a total amount and daily average amount.

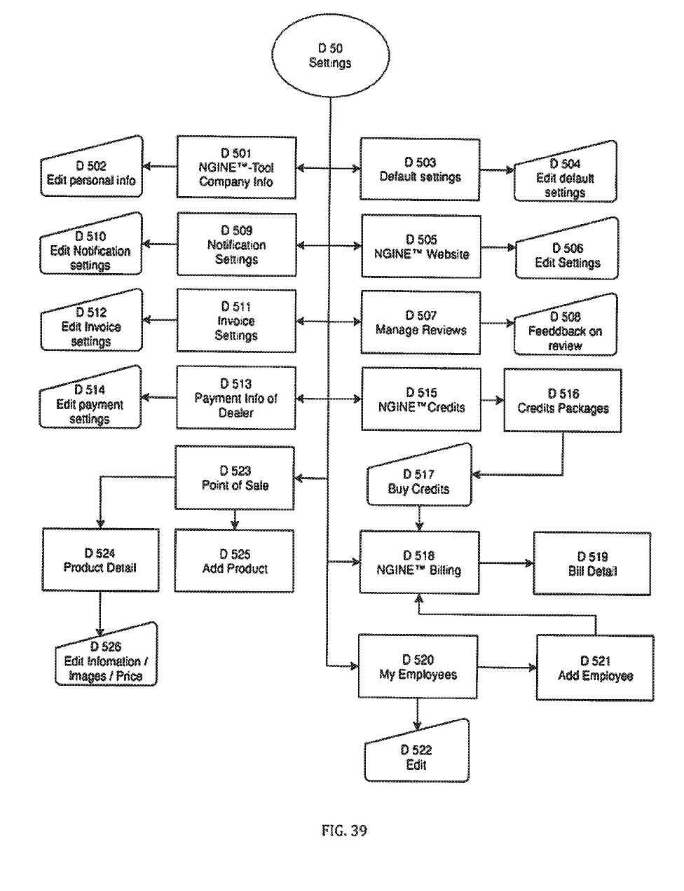

Referring not to FIG. 39 settings module D50 with which a user can manage personal tools in the NGINE™ system to view and edit, change default settings, manage reviews, change notification settings, invoice settings, credits, billing, payment information, my employees and POS. Tool company module 501 includes complete company information. Edit personal module D502 provides for an edit of company or personal information. Default settings module D503 provides for a display of default settings and edit default settings module D504 requires a manual input to edit information in default settings in default settings module D503. Notification settings module D509 provides a display of notifications and settings and edit notification settings module requires a manual input to edit information in module D509. Server or NGINE™ website module D505 displays setting options for building a website and edit settings module D506 requires a manual input to edit information in module D505. Invoice settings module D511 provides a display of invoice template options and edit invoice settings module D512 requires a manual input to edit information in module D511. Managing reviews module D507 displays a list of received reviews and feedback on review module D508 allows the user to respond to received reviews. Payment info module D513 displays payment information and edit payment settings module D514 requires a manual input to edit information in module D513.

NGINE™ credits module D515 displays a credit balance for transactions on the novel server NS10. NGINE™ credits modules D515 is linked to a credits packages module D516 which displays credit packages which is linked to buy credits module D517 which requires a manual input to purchase a credit package. Buy credits package is linked to NGINE™ billing module D518 which displays all invoices related to the purchase of NGINE™ credits or the adding of employee access to the NGINE™ tool. Billing module D518 is linked to bill detail module D519 which displays detailed information on a particular chosen invoice.

Settings module D50 is also linked to NGINE™ billing module and my employees module D520 which in turn is linked to add employee module D521 which provides for the addition of employees to my employees module D52. Edit module D522 requires a manual input to add employee module D521 or edit employee information.

Settings module D50 is also linked to point of sale module D523. Point of sale module D525 is linked to add a product module D525 to add a POS product. Point of sale module is also linked to product detail module D524 which provides detailed information about POS products and quantities in stock. Product detail module D524 is also linked to edit information module D526 which requires a manual input to add product information, price and pictures.

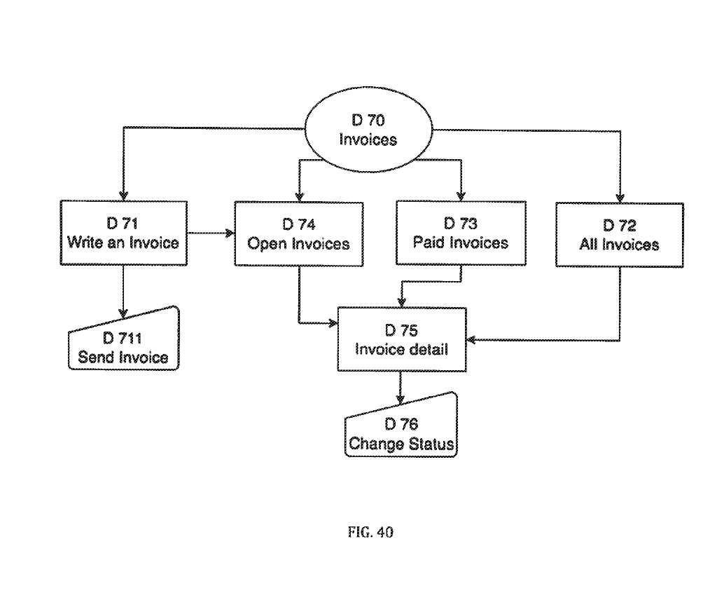

Referring now to FIG. 40 invoices module D70 allows the user to manage all invoices for services provided and goods sold as well as generating an invoice, view and manage all invoices. Invoices invoice module D70 is linked to write an invoice module D71 which can generate an invoice based on products and services delivered and with send an invoice module D711 send an invoice by e-mail or any other media tool to designate a receivable. Invoices module D70 is also linked to open invoices module D74 which displays all open invoices and paid invoices module D73 which displays all paid invoices. Both open invoice module and paid invoices are linked to an invoice detail module D75 which displays detailed information on all invoices. Invoice detail module D75 is also linked to change status module D76 which allows the user to manually change the status of an invoice. Invoice module D70 is also linked to invoice detail module D75 through an all invoices module D72 which provides a display of all invoices.

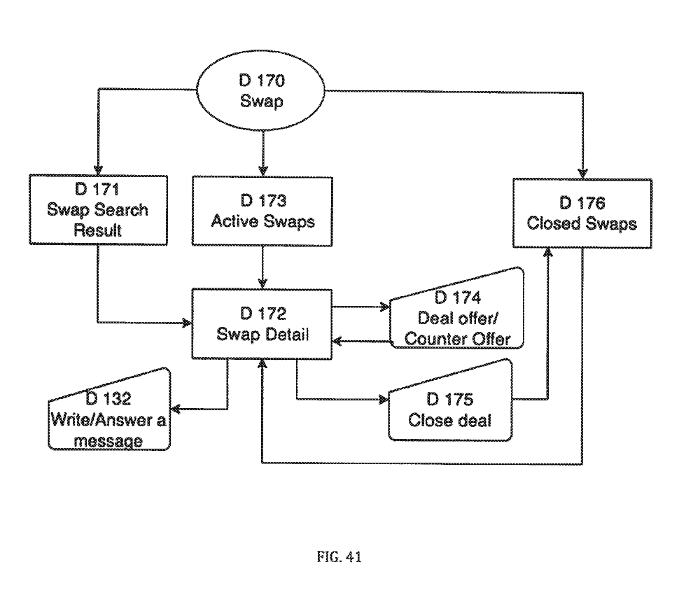

Referring now to FIG. 41 swap module D170 allows a user to swap a vehicle with a certified dealer or with another user of the novel server NS10. The swap can only proceed with a dealer or manufacturer of the same brand. Swap module D170 is linked to swap search result module D171 which displays search results for swap opportunities as well as active swaps module D173 which lists all suggested swap opportunities as well as closed swaps module D176 which displays all closed swaps. Active swaps module D173 and swap search results module D171 are linked to a swap details module D172 which displays information on a particular swap arrangement. The swap detail module D172 is linked to the deal offer/counter offer module D174 which requires a manual input to implement a payment in addition to a swapped vehicle if the value of the swapped vehicle is not equal to the offered vehicle. The swap deal module D172 is also linked to write/answer module D132 to allow the parties to send messages to each other as heretofore discussed. Swap detail module D175 is also linked to close deal module 175 which requires a manual input to indicate a deal is closed which then is linked to closed swaps module 176 which displays all closed swaps which is then linked to swap module D170.

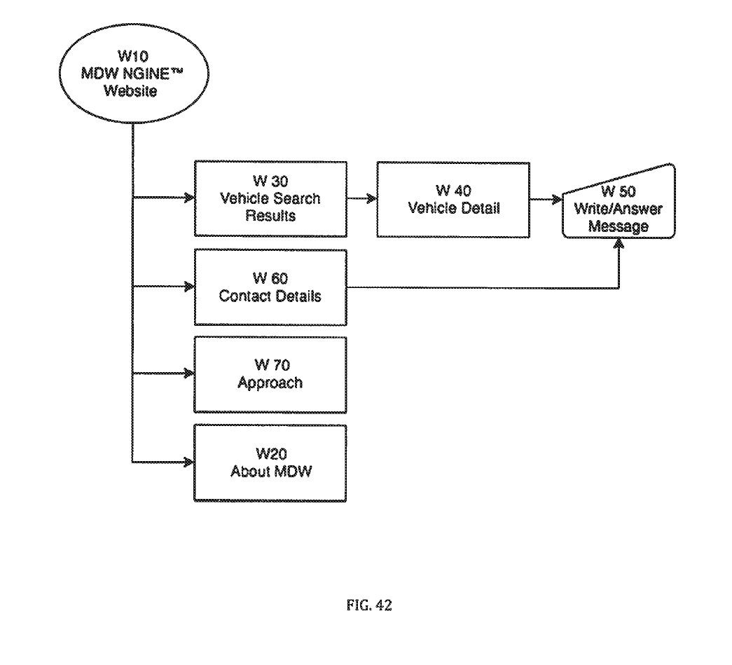

Referring now to FIG. 42 the novel server or NGINE™ server NS10 is connected to the internet by a website W10 which displays MDW's products services and profile of each MDW and contact details based on a display of the setting options provided in module D505. The novel server NS10 is linked to a vehicle search results module W30 which displays all types of advertised vehicles. Vehicle search results module W30 is linked to vehicle detail module W40 which provides detailed information on a particular vehicle displayed. The vehicle display is the same view as seen by a consumer or user in module C18. If the customer contacts the dealer from the novel NS10 server the system generates the transaction as a lead and provides this information to the CRM in the NGINE™ tool in the leads module D31.

Vehicle detail module W40 is linked to write/answer message module W50 which requires a manual input to start a conversation or answer a message.

Server NS10 is also linked to a contact details module W60 which displays a MDV contact detail which is also linked to write/answer module W50. Server NS10 is also linked to an approach W70 module to display a MDW's address and directions and an about MDW W20 module which displays available profile of the MDW including the business profile and sales and contact information.

Referring now to FIG. 49 an alternative embodiment of the customer C10 module is illustrated in an iterative embodiment of the novel server NS10. FIG. 49 like FIG. 9 includes the same modules namely the search result module C17, the offer page module C18 linked to the sign up module C11 and the sign in module C114. In addition both FIG. 49 and FIG. 9 have a plurality of ABC banks C3361 and ABC insurance companies. FIG. 9 however has the bank in first in a sequence process so that bank approval is required before proceeding to the next step.

In FIG. 49 in contrast to FIG. 9 each vertical service having a plurality of horizontal service providers such as banks C3361 A, B, C, etc., insurance providers C3331 and any other vertical service such as logistic company L10 needed to complete the vehicle transfer process is accomplished in an iterative non sequential process in which an iterative module in the novel NS10 server accesses each service provider required to complete the transaction to transfer the vehicle and simultaneously and iteratively seeks the lowest bid from each service provider required to complete the transfer. As a result as shown in FIG. 49 service package module C325, insurance module C3331 and bank module C3361 continue the iterative process until the lowest bid is obtained from each service provider as each service provider provides an updated bid with the lowest bid displayed to every other service provider until the lowest possible bid is obtained from each bidder or the user selects a particular low bid. In an alternative embodiment a Fuzzy Logic Processor is utilized in the novel NS10 server to select the lowest and best bid from the plurality of service providers. Where a Fuzzy Logic Processor is utilized to obtain the best price the Fuzzy Logic Processor is coupled with a timer to provide pulses of time for each of the plurality of transactions to complete the transfer of the vehicle from the manufacturer or dealer to the end user.

As used herein and in the claims the term “customer”, “end user” and “purchaser” have been used interchangeably. It is recognized that sometimes a customer is not an end user and sometimes an end user is not a customer. However as used herein and in the claims such distinctions are without a difference as the customer or end user or purchaser seek a transfer of a vehicle based on the reputation of the manufacturer and data obtained from the novel server NS10.

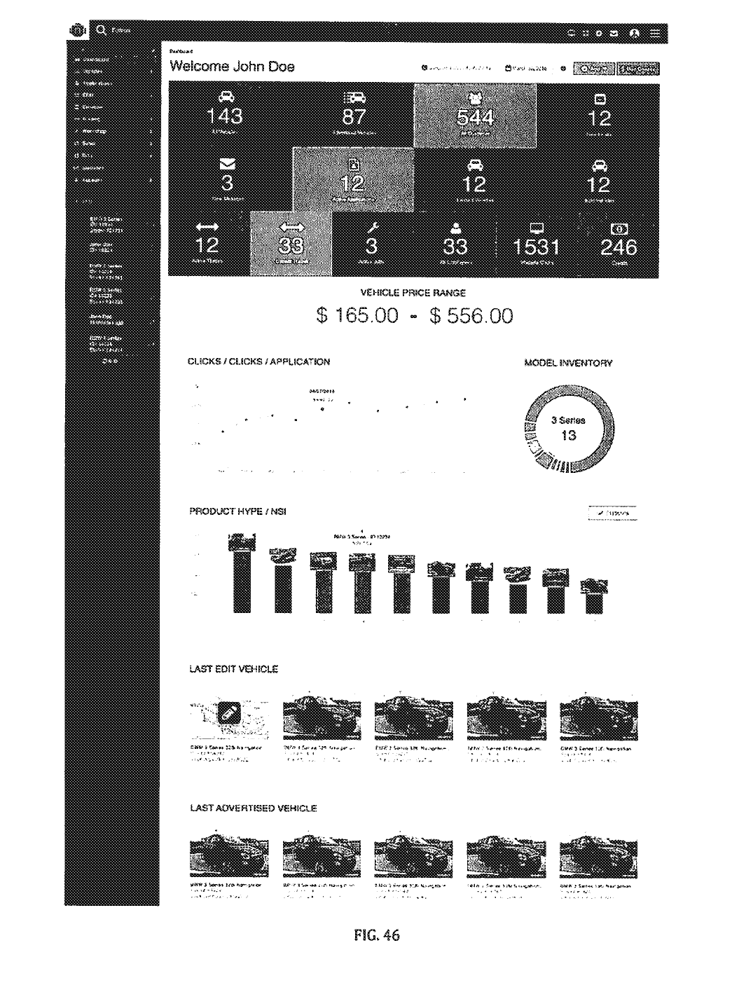

It will be recognized by one skilled in the art that the invention may be implemented in a number of different ways. It will also be recognized that the method and its steps do not need to be utilized in a specific order and that the steps of the method may be arranged or is rearranged and additional steps may be added without departing from the spirit of the invention. The invention has not been launched or placed in public use or sale therefore the screen illustrations in FIGS. 43-48 while realistic may be changed when the invention is launched or put into practice. In addition modifications in implementing the invention are expected and that such expected modifications are within the scope of the appended claims. As used herein and in the following claims, the words “comprising” or “comprises” is used in its technical sense to mean the enumerated elements are included but do not exclude additional elements which may or may not be specifically included in the dependent claims. It will be understood such additions, whether or not included in the dependent claims, are modifications that both can be made within the scope of the invention. It will be appreciated by those skilled in the art that a wide range of changes and modification can be made to the invention without departing from the spirit and scope of the invention as defined in the following claims.

What is claimed is:

1. An electronic system to integrate horizontal and vertical vehicle data links comprising:
(a) a server configured to receive and provide data on a plurality of vehicles;
(b) a module linking an end user of a vehicle to a plurality of vehicle manufacturers;
(c) a database configured to receive and store data on a plurality of vehicles connected to the server;
(d) a module linking the end user of the vehicle to the plurality of vehicle manufacturers through the database and server to provide at least one of a purchase, lease or rental option based on a selected end user option with vertical links to complete the selected end user option and horizontal links associated with each vertical link;
(e) an electronic device to electronically select the best price associated with each vertical link and adjust data from each vertical link to complete the selected end user option; and
(f) a communication interface between the database server, the plurality of vehicle manufacturers and the end user.

2. The electronic system of claim 1 wherein the module is a virtual reality module.

3. The electronic system of claim 1 further comprising a service management system module in the server linking at least one of the plurality of vehicle manufacturers to a plurality of service providers for the vehicle.

4. The electronic system of claim 1 further comprising a bid module for each finance horizontal link and each insurance horizontal link.

5. The electronic system of claim 1 further comprising a trade in module.

6. The electronic system of claim 1 further comprising a telematics module.

7. The electronic system of claim 1 further comprising a vehicle maintenance module.

8. The electronic system of claim 1 further comprising an end user dashboard module.

9. The electronic system of claim 1 further comprising a vehicle manufacturer dashboard module.

10. The electronic system of claim 1 wherein the database tracks a history of components repairs and service of each vehicle based on a vehicle VIN number.

11. The electronic system of claim 1 further comprising a swap module.

12. The electronic system of claim 1 further comprising a user verification module.

13. The electronic system of claim 1 further comprising a manufacturer and end user relationship management module.

14. The electronic system of claim 1 further comprising (POS) point of sale module in the server.

15. The electronic system of claim 1 further comprising a roadside service module.

16. The electronic system of claim 1 further comprising a comparable vehicle module,

17. The electronic system of claim 1 further comprising a voice recognition module.

18. A method of producing and transferring vehicles comprising:
(a) setting up a database server having data on a plurality of vehicles produced by at least one manufacturer;
(b) linking the database server to at least one end user and the at least one manufacturer;
(c) enabling the end user to interface with the manufacturer or a dealer of the manufacturer and select purchase, lease rental, trade or other transaction to transfer the vehicle;
(d) providing a group of vertical links to services required to complete the transfer of the vehicle wherein the group of vertical links include at least one member selected from the group of resources including financing, insurance and vehicle maintenance;
(e) establishing a horizontal link among each member of the vertical links to have each member of the vertical link provide a competitive price for each vertical link; and
(f) having an electronic data device adjust each competitive price for each vertical link to provide a calculated complete transfer price.

19. The method of claim 18 wherein the step of linking includes a virtual reality link.

20. The method of claim 18 further comprising the step of maintaining records on the transferred vehicle through its vehicle identification a number (VIN) to determine if the vehicle has been maintained in accordance with the manufacturer's recommendations and make changes in the manufacture of additional similar vehicles as warranted.

21. The method of claim 20 further comprising the step of electronically notifying each end user when maintenance is due on the vehicle.

22. The method of claim 21 wherein the step of notifying each end user when maintenance is due includes the step of having members of the vehicle maintenance group provide competitive bids to complete the maintenance.

23. The method of claim 18 wherein the step of setting up a database includes a plurality of manufacturers wherein at least one manufacturer is selected from the group of automobile, aircraft, boat, motorcycle, truck and autonomous and semi autonomous vehicle manufacturers.

24. The method of claim 18 further comprising the step of creating an electronic vehicle history database on the mileage history, end user or consumer complaints, accident history, incident history and service problem or difficulties from one or more members of the vehicle maintenance group.

25. The method of claim 24 further comprising the step of utilizing the electronic vehicle history database to determine the fair market value of the vehicle in a further transfer of the vehicle.

26. The method of claim 24 further comprising the step of utilizing the electronic vehicle history database to change manufacturing assembly line procedures or components used in the assembly of additional vehicles.

27. The method of claim rein the electronic vehicle history database includes data on each component used in a transferred vehicle and tracked by accident history end user or consumer complaints, incident history and service problems or difficulties for each vehicle component.

28. The method of claim 27 wherein the electronic vehicle history database is used to change a supplier of a component in the assembly of additional vehicles.

29. The method of claim 27 wherein the electronic vehicle history database includes data on a supplier of a component of a transferred vehicle as well as the use of the same supplier for the component of a different vehicle manufactured by other manufacturers.

30. The method of claim 27 wherein the electronic vehicle database is used to change a supplier of a component in the assembly of additional vehicles by more than one manufacturer of a vehicle.

31. A method for transferring and manufacturing safer vehicles comprising:
(a) creating a direct electronic link between a vehicle manufacturer and an end user through an internet connection between a computer of the end user and a host computer of the vehicle manufacturer or through a host website computer connected to the computer of the vehicle manufacturer;
(b) transferring a vehicle from a dealer or the vehicle manufacturer to the end user through the internet connection or through the host website computer;
(c) tracking components in the transferred vehicle from their assembly in the transferred vehicle throughout their use in the transferred vehicle through the host computer or through the host website computer;
(d) providing a database of components tracked in transferred vehicles connected to the host computer or through the host website computer, said database having data from at least one member of the group consisting of fatal accident reports, accident reports, incident reports and consumer or end user complaints; and
(e) utilizing the database and the host computer or the host website computer to change a Vehicle production line for assembling additional vehicles or the components placed in additional vehicles when fatal accident reports, accident reports, incident reports, dealer service reports and end user complaints exceed a threshold.

32. The method for transferring and manufacturing safer vehicles of claim 31 wherein the database of tracked components includes data on vehicle use or mileage and the age of the component.

33. The method of transferring and manufacturing safer vehicles of claim 33 wherein the step of transferring includes a group of vertical links to services to complete transferring the vehicle to the end user or customer with horizontal links connected to each vertical links with horizontal links associated with each vertical link to provide a competitive bidding between horizontal members in each vertical link.

34. A computer implemented apparatus for controlling required paperwork transactions for transferring a vehicle comprising:
(a) a module coupled to said computer containing a list of required paperwork transactions to transfer said vehicle;
(b) a time generator coupled to the list of required paperwork transactions generating pulses indicative of speed required to complete the time interval to complete each item on the list to complete each transaction for said transfer of said vehicle;
(c) a plurality of bi-directional links to link vendors of services of each item of the list to obtain a bid price for each item on the list to complete each transaction for said transfer of said vehicle and supply each vendor with the lowest price bid for each item on the list;
(d) a fuzzy logic processor coupled to the bid price for delivering a control parameter to the time generator, said control parameter causing a completion of the time interval required to complete each item on the list wherein said processor updates the control parameter using a fuzzy logic relationship based on reputation and past performance of each vendor for service provided by each vendor for each item on the list to complete each transaction for said transfer of said vehicle.

35. The computer implemented apparatus of claim 34 wherein the list of paperwork transactions includes bill of sale, insurance, financing, title tags and registration of a new vehicle.

36. The computer implemented apparatus of claim 35 wherein the list of paperwork transactions includes bill of sale and cancellation of insurance, financing and termination or transfer of title, tags and registration of a previously owned or leased vehicle.

37. A method for transferring vehicles comprising:
(a) having at least one server computer in communication with a computer network;
(b) imputing to the server paperwork transactions needed to transfer said vehicle;
(c) connecting a buyer client computer to the server;
(d) connecting a plurality of client server computers to the server, said plurality of client server computers each having paperwork transactions including bill of sale, insurance, financing and registration needed to transfer said vehicle;
(e) obtaining bids from each of said plurality of client server computers on at least one paperwork transaction needed to transfer said vehicle and having the server computer transfer data to the buyer client computer of the lowest bids;
(f) allowing the buyer client computer provide data to the server computer to determine which bid to accept from each client server computer to complete the paperwork transactions needed to transfer the vehicle;
(g) calculating and completing all paperwork transactions needed to transfer the vehicle in the server computer; and
(h) transferring data from the server computer to the buyer client computer to print all paperwork transactions and data needed to transfer said vehicle.

38. The method of claim 37 further comprising the step of connecting a plurality of client purchaser server computers to the server to complete all paperwork to transfer a previously owned or leased vehicle.

39. An electronic apparatus comprising:
(a) at least one server computer having an interface to communicate over a computer network;
(b) a program code disposed in the at least one server configured to link a vehicle customer or end user to a plurality of vehicle manufacturers to transfer a vehicle to the vehicle customer or end user with horizontal links to each of the plurality of vehicle manufacturers and at least one vertical link to at least one number of a group of resources consisting of a financing resource, an insurance resource, a vehicle registration and a vehicle delivery resource to allow each member of the group of resources to submit a bid;
(c) an electronic adjustment device to select the lowest bid from each member of the group of resources and electronically select and tabulate the lowest total price for the delivery of the vehicle; and
(d) a connection connecting a plurality of client computers to the at least one server computer to the Internet.

40. The electronic apparatus of claim 39 further comprising a trade in program code.

41. The electronic apparatus of claim 39 further comprising a vehicle maintenance code to track each vehicle transferred based on its vehicle identification number (VIN).

42. The electronic apparatus of claim 39 wherein the group of resources includes a horizontal group of vehicle maintenance resources.

43. The electronic apparatus of claim 42 wherein the vehicle customer or end user is alerted to when the vehicle needs maintenance and the horizontal group of vehicle maintenance resources are given a description of the required vehicle maintenance in order to submit bids to the vehicle customer or end user on maintenance.

44. The electronic apparatus of claim 43 wherein the horizontal group of vehicle maintenance resources are authorized by a vehicle manufacturer to maintain the vehicle under warranty.

45. The electronic apparatus of claim 39 wherein the program is further configured to record data from customer or end use complaints, vehicle computer reports, incidents and accident reports involving the vehicle or similar vehicles with some of the same components and service reports from a vehicle maintenance facility and tabulate and report that data to the vehicle manufacturer to change assembly line production or components in the manufacture of new vehicles or models.

46. The electronic apparatus of claim 39 further comprising a search engine for searching each vehicle transferred based on its vehicle identification number (VIN).

47. A web based iterative system for transferring vehicles comprising:
(a) a server computer in communication with a computer network having a plurality of links to vehicle manufacturers, vehicle financing, vehicle insurance, vehicle registration and vehicle delivery sources;
(b) at least one client computer in communication with the server computer where the client computer is in search of the best available terms for the transfer of a vehicle;
(c) at least one client computer input to the server computer as to the type of vehicle selected to enable the server computer to select a vehicle manufacturer and obtain a basic pro forma term for the transfer of the vehicle; and
(d) a server computer module to start the iterative process of collection alternative bids from other sources for vehicle financing, vehicle insurance, vehicle registration and vehicle delivery processes and updating and presenting the lowest bid and identifying the bidder from each of the other sources until the at least one client computer selects the pro forma bid or one bid from the vehicle finance source, vehicle insurance source, vehicle registration and vehicle delivery source.

48. The web based iterative system of claim 47 further comprising a server computer module to start an iterative process for collecting bids from prospective purchasers upon an input from a client computer.

49. The web based iterative system of claim 47 wherein the server computer has a memory module for storing data on each vehicle transferred.

50. The web based iterative system of claim 49 wherein the memory module stores data on all service and warranty data on each vehicle transferred.

51. The web based iterative system of claim 50 wherein the service and warranty data is provided to obtain the highest bid from prospective purchasers.

52. A computer implemented apparatus for controlling the speed of a vehicle transfer transaction comprising:
(a) at least one server computer in communication with a computer network having an end user and a plurality of links to vehicle dealers and at least one vehicle manufacturer;
(b) a timer to generate data on a plurality of transactions needed to complete a transaction to transfer a vehicle from the vehicle manufacturer to the end user and provide a plurality of pulses of time intervals taken by the end user on each link to the plurality of transactions needed to complete the transaction to transfer the vehicle from the vehicle dealer or vehicle manufacturer to the end user;
(c) a fuzzy logic processor coupled to the timer for delivering the best price within each of the pulses of time provided by the end user on each of the plurality of transactions to complete the transfer of a vehicle from the vehicle dealer or the vehicle manufacturer to the end user; and
(d) an iterative module to update each transaction of the plurality of transactions to complete the transfer of the vehicle coupled to the processor to obtain the best price within the total plurality pulses of time to complete the vehicle transfer transaction.

53. The computer implemented apparatus of claim 52 wherein the at least one server computer has a virtual reality link to the vehicle manufacturers.

54. The computer implemented apparatus of claim 53 wherein the virtual reality link is connected to the processor.

55. The computer implemented apparatus of claim 52 further comprising a database in the server computer to store data on insurance, maintenance history, warranty, lease, purchase agreements on contract data on each vehicle transferred for the manufacturer or dealer.

56. The computer implemented apparatus of claim 52 further comprising a user identification database to identify a user by a facial scan or a fingerprint.

57. The computer implemented apparatus of claim 52 wherein the server computer stores all documents on all the transactions which completed the transfer of the vehicle.

58. A method for transferring and manufacturing safer vehicles comprising:
(a) creating a direct electronic link between a vehicle manufacturer and an end user through an internet connection between a computer of the end user and a host computer of the vehicle manufacturer or through a host website computer connected to the computer of the vehicle manufacturer;
(b) transferring a vehicle from a dealer or the vehicle manufacturer to the end user through the internet connection or through the host website computer;
(c) tracking components in the transferred vehicle from their assembly in the transferred vehicle throughout their use in the transferred vehicle through the host computer or through the host website computer;
(d) providing a database of components tracked in transferred vehicles connected to the host computer or through the host website computer, said database having data from at least one member of the group consisting of fatal accident reports, accident reports, incident reports, dealer service reports and end user complaints; and
(e) utilizing the database and the host computer or the host website computer to transform a vehicle production line for assembling additional vehicles or the components placed in additional vehicles when fatal accident reports, accident reports, incident reports, dealer service reports and end user complaints exceed a threshold.
